(19) United States
(12) Patent Application Publication
(10) Pub. No.: US 2025/0041840 A1
(43) Pub. Date: Feb. 6, 2025

(54) PHOTOCATALYTIC AEROSOL

(71) Applicants: Franz Dietrich Oeste, Kirchhain (DE); Clive Thomas Elsworth, London (GB)

(72) Inventors: Franz Dietrich OESTE, Kirchhain (DE); Clive Thomas ELSWORTH, London (GB)

(21) Appl. No.: 18/697,139

(22) PCT Filed: Aug. 9, 2022
(86) PCT No.: PCT/DE2022/100581

§ 371 Date: Mar. 29, 2024

(30) Foreign Application Priority Data
Oct. 1, 2021 (DE) 10 2021 004 929.2
Dec. 3, 2021 (GB) 2117512.0
Apr. 21, 2022 (DE) 10 2022 001 364.9
Apr. 23, 2022 (DE) 10 2022 001 393.2
May 8, 2022 (DE) 10 2022 001 608.7
Jun. 7, 2022 (DE) 10 2022 001 961.2
Jun. 10, 2022 (DE) 10 2022 002 100.5

(51) Int. Cl. B01J 35/23; B01D 53/76; B01D 53/88; B01J 13/00; B01J 35/39; B01J 37/04; B01J 37/34

(52) U.S. Cl. CPC B01J 35/23; B01D 53/76; B01D 53/885; B01J 13/0095; B01J 35/39; B01J 37/04; B01J 37/349; B01D 2251/504; B01D 2251/60; B01D 2255/20707; B01D 2255/20738; B01D 2255/802; B01D 2255/90; B01D 2257/7025

(57) ABSTRACT

A self-activating photoactive aerosol is presented, comprising an anion-containing mass composition having a mass ratio of nitrate anions and/or nitrogen-oxygen compounds to chlorides ranging from 1 part nitrate anions and/or nitrogen-oxygen compounds to 200 parts chlorides, up to 10 parts nitrate anions and/or nitrogen-oxygen compounds to 1 part chlorides, and the composition has a pH in a range of less than or equal to 3 to greater than or equal to −1. Also disclosed is method and apparatus for producing a self-activating photoactive aerosol.

### TECHNICAL FIELD

The present disclosure relates to a self-activating photoactive aerosol, such as for methane degradation in the atmosphere and/or for exhaust gas treatment or purification, a method for producing an aerosol, a device with which such an aerosol can be provided, and an exhaust gas treatment system which operates on the basis of the aerosol.

### BACKGROUND

In principle, methods are known for removing climate-damaging substances such as greenhouse gases from the atmosphere, see in particular the earlier patent application WO 2010/075856 A1. One of the aims is to exert a direct influence on the climate and primarily on climate change by reducing greenhouse gases and to reduce the general warming of the atmosphere.

In view of the effects of climate change methods are also being sought worldwide to stimulate increased growth of phytoplankton in the sea and thus absorb CO₂ from the atmosphere, possibly on a gigatonne scale. Iron(III) chloride aerosol plumes in the atmosphere, which could be emitted from smokestacks, for example, could bring about climate cooling and other environmental benefits through photochemical degradation of methane and other organic compounds in the atmosphere, physical cloud formation, brightening of existing clouds and enhancement of biologically induced CO₂ absorption in the ocean.

For example, a cloud of iron(III) chloride aerosol particles can be generated by sublimation of solid, anhydrous iron(III) chloride at temperatures between 20° and 300° C. Such a process is also described in the application “Method for Cooling the Troposphere” (WO 2010/075856 A1) from 2010.

However, one problem with the sublimation of iron(III) chloride is the decomposition of the resulting iron(III) chloride vapor to solid iron(II) chloride and elemental chlorine, which begins in the temperature range above 200° C. This can lead to clogging of the sublimation device with precipitated solid iron(II) chloride. This can lead to clogging of the sublimation device with precipitated solid iron(II) chloride. In addition, impurities containing oxygen and/or water vapor in the sublimation chamber tend to oxidize gaseous iron(III) chloride at the sublimation temperature to solid oxygen-containing iron compounds, which also leads to clogging of the sublimation chamber. In addition, in this temperature range, the surfaces of the iron(III) chloride starting materials in the iron(III) chloride bed and the walls of the sublimation chamber are coated with the solid reaction products. This reduces the yield of iron(III) chloride vapor. Another difficulty with the aforementioned application from 2010 is the potentially inadequate mixing between the iron(III) chloride vapor and the gas jet. This is due to the fact that the iron(III) chloride vapor is simply injected into the gas jet without using further mixing effects. Insufficient mixing reduces the proportion of iron(III) chloride aerosol particles and/or droplets (hereinafter referred to as “aerosol particles” or implicitly included in the term “aerosol”) with a diameter<0.1 m in the resulting aerosol plume. This reduces the reaction area on the emitted particles for the photolytic generation of chlorine atoms for methane degradation in the troposphere (as described in Oeste et al., 2017). In addition, larger aerosol particles have a shorter lifetime in the air.

The targeted influencing of the earth's climate is still predominantly a research matter, since, as explained above by way of example, these and numerous other hurdles have to be overcome and the provision of a sufficiently large climatic effect has also been problematic to date. It is precisely the provision of the device on the one hand and the composition of a climatically active substance on the other that is considerably further developed with the present application.

In this area, efforts are being made from many sides to provide further developments. For example, WO 2022/053603 A1 describes a potential method for the oxidative degradation of methane by chlorine atoms. One undesirable result of the process described there is the high amount of energy required, in particular for the provision of ultraviolet radiation, and therefore a questionable energy balance or economic exploitability.

The present disclosure summarizes the current status of further developments and supplements this with further aspects. The aspects are already described in part in the following priority applications, which are hereby incorporated by reference: DE 10 2021 004 929.2, DE 10 2022 001 364.9, DE 10 2022 001 393.2, DE 10 2022 001 608.7, DE 10 2022 001 961.2, DE 10 2022 002 100.5 and GB 2 117 512.0.

With the new aerosol and its production according to the claimed new process, the degradation of atmospheric methane by the claimed chloride mixture aerosol can be accelerated. For example, an acidic ferric salt mixture aerosol can be used as the chloride mixture aerosol, which, however, is desirable when a comparable iron content is used in the ferric salt mixture aerosol. This is accompanied by the benefit that less iron has to be emitted into the environment in order to oxidize the same mass of methane within a given period of time. On the other hand, the claimed process can also be used with a very low iron content in the aerosol or without any iron content in the aerosol at all, for example for methane degradation in the atmosphere.

In the present disclosure, chloride is used as a generic term in the case of a “chlorine-containing aerosol”. In particular, this includes the hydrolysable chlorides (TiCl₄, SiCl₄, AlCl₃, FeCl₃, Cl₂, NOCl, NO₂Cl, NO₃Cl, HCl, chloride, seawater) and the chloride anions. In the following, “chloride” is used instead of chlorine for all chlorine-containing substances or compounds used here, as they are predominantly classified as hydrolysable chlorides.

In an acidic environment, mixtures of hydrochloric acid and nitric acid, for example the mixture known as Aqua Regia, are among the most aggressive and corrosive liquids due to their acidic and oxidizing effect because they release elemental chlorine. In this description, aerosol compositions containing nitric acid and hydrochloric acid are summarized under the term “Aqua Regia”. The composition can correspond to Aqua Regia, but it can also have a comparable effect only with regard to the release of chlorine and/or chlorine atoms, but not the exact mixing ratio of Aqua Regia, for example a lower concentration, a different mixing ratio, activating admixtures or a higher pH value than the classic Aqua Regia. In other words, “Aqua Regia” in this context refers to an Aqua Regia analog. Numerous aerosol compositions are listed in the present description which, when sufficiently reacted, are referred to as “Aqua-Regia” in this context. The “Aqua-Regia” preferably has a pH of 3 or less, for example in the range of 3 to −1, preferably 2 or less.

The oxidation effect of “Aqua-Regia” can be used in the light of the processes described in detail below or in the light of the devices described in detail below, such as for the degradation of the greenhouse gas methane, the degradation of combustion exhaust pollutants or tropospheric ozone, as will also be explained below.

Sunlight photolysis of the claimed acidic “Aqua Regia” aerosol, for example containing HNO₃—, nitrate-, chloride- and HCl-containing ferric chloride and/or titanium hydrolysate, increases the effectiveness of the “Aqua Regia” oxidation effect, because both the released elemental chlorine from the non-photolytic classic Aqua Regia oxidation reaction is photolytically split into chlorine atoms and the additional chlorine atoms formed by the photolysis of the Aqua Regia ingredients can be converted into NO₂ radicals, water and chlorine atoms by photolytic conversion of nitrate and nitric acid in the presence of chloride. Depending on the aerosol composition, sunlight photolysis of ferric salts to ferrous salts may also occur, which leads to nitrogen trioxide radicals with nitrates, which form chlorine atoms with chlorides and whereby ferric chloride photolysis leads to direct chlorine atom formation. From a chemical point of view, titanium hydrolysates can also be photolyzed to form titanium(III)hydrolysates, whereby the corresponding reaction chains in the “aqua regia” environment also typically end in the formation of chlorine atoms. In contrast to hydroxyl radicals, the chlorine atoms do not have a pronounced polarity and therefore pass directly into the gas phase, where they meet their reaction partners, such as methane, smoke aerosols and ozone, and initiate their oxidation or degradation with conversion to HCl.

Despite the chemical reactivity, the aerosol used and the oxidation achieved by the aerosol, such as of methane, are environmentally friendly processes. Natural processes can be observed in which pH<1 acidic ferric salt aerosols from mineral dust drifts, erupted volcanic ash or urban emissions are used in the atmosphere without any undesirable results for ecosystems. As soon as these natural or artificial aerosols are washed out of the atmosphere by precipitation, their acidic conditions are blunted by rainwater and neutralized in contact with soil, rock and ocean. As a result, the pH value can quickly rise to slightly alkaline pH values at the ocean surface and, depending on the soil or rock type, to slightly alkaline to slightly acidic pH values at the land surface. With regard to the artificial aerosols claimed here, their emission is likely to be regulated in such a way that they can only fall in large dilutions, for example predominantly on the ocean surface. However, due to the aggressiveness of the claimed acidic chloride mixed aerosol, its production is not trivial. Depending on the design of the device, a high acid resistance of the device components may be desirable.

In the light of this, the inventors of the present application have described in the present disclosure numerous approaches for how the methods and devices presented can be constructed and/or used in a pragmatic and practicable manner. In one aspect of the description, attention is paid to ensuring that sufficient volumes can be provided while keeping the energy requirement as low as possible.

Furthermore, in one aspect, the disclosure has set itself the task of detecting potentials to utilize man-made or natural pollutant emissions for the present disclosure in such a way that the pollutant emission can be reduced and/or the effect or amount of the aerosol presented herein can be increased.

A further focus of the present disclosure is to further simplify the process compared to previous ideas, such as to simplify the precursors to be provided or, respectively, simplify their production, so that possibly even less or no amounts of substances of additives or additives at all have to be introduced into the aerosol or their production.

The problem is solved by the disclosure defined in the independent claims. Dependent claims provide further embodiments and preferred embodiments of the disclosure.

A self-activating photoactive aerosol according to the present description comprises a mass composition containing anions. The mass composition describes the substance masses or the ratios of the substance masses of the atoms, radicals or compounds contained in the mass composition to one another. For example, nitrates have a mass of 62.0049 g/mol and chloride has a mass of 35.453 g/mol. If a ratio of substance masses is specified in the mass composition, the amount A to the amount B can be specified, for example. This does not exclude the possibility that a substance C or a substance D is also contained or in what quantity other substances are contained.

The bulk composition has a mass ratio of nitrate anions and/or nitrogen-oxygen compounds to chlorides from 1 proportion of nitrate anions and/or nitrogen-oxygen compounds to 200 proportions of chlorides up to 10 proportions of nitrate anions and/or nitrogen-oxygen compounds to 1 proportion of chlorides.

Further, the mass composition comprises a pH value in a range of less than or equal to 3 to greater than or equal to −1, i.e., in the range of 3 to −1 (inclusive in each case).

The mass composition may further preferably comprise between 0.2 and 2.5 sulfur compounds per anion contained in the aerosol, preferably between 0.5 and 1.5 sulfur compounds, wherein the sulfur compounds may comprise, for example, sulfur dioxide molecules and/or hydrogen sulfate.

In a preferred manner, the mass composition may further comprise metal compounds. The metal compounds of the mass composition preferably comprise metals from the subgroup elements of the periodic table, or compounds comprising subgroup elements of the periodic table, and/or alkali metals and/or alkaline earth metals. The metal compounds, such as the subgroup metal compounds, can be present in a mass ratio from 1 proportion of metal compounds to 1000 proportions of anions up to 1 proportion of metal compounds to 3 proportions of anions. In other words, metal compounds may be present in the emitted aerosols, for example, in one of the forms chlorides, nitrates, ions, hydroxides, oxide hydrates or oxides. Preferred metal compounds are those of iron, titanium, manganese, copper and zinc. The side group metal compounds may include, for example, ferric ions or cations, ferro ions or cations, ferric oxides, ferric hydroxides, iron(III) oxide hydrate, manganese cations, manganese(IV) oxides, manganese ions, permanganate ions, titanium compounds such as titanium dioxide, titanium tetrachloride and/or a hydrolysis product of titanium tetrachloride. Typically, when metals and metal compounds are mentioned in the further description, those of the sub-group metals and sub-group metal compounds are mentally in mind, although this is not provided to exclude the possibility that the methods and production cycles mentioned can also be carried out with other metals and metal compounds.

Furthermore, the nitrogen-oxygen compounds of the mass composition may further preferably comprise a substance from the side group metal compounds such as nitrate or nitrite, iron nitrate, iron nitrite, titanium dioxide, hydrolysis product of titanium tetrachloride, nitric acid, NO, NO₂, NO₃, N₂O₃, N₂O₄, N₂O₅. In other words, the anions may be present as a metal-nitrogen-oxygen compound.

The mass ratio between nitrogen-oxygen compounds and chlorides set in the mass composition can preferably be between 0.5 parts to 100 parts and 10 parts to 1 part. This mass ratio can be present in part or completely in the condensed aerosol phase, i.e., in aerosol droplets.

A mass fraction of nitrogen-oxygen compounds can cumulate with a mass fraction of nitrate, for example in the condensed phase of the aerosol, to form a mass fraction of nitric acid precursors. In each case, a proportion of nitrogen-oxygen compounds, such as in the condensed phase of the aerosol, can oxidize and/or hydrolyze to form at least a proportion of nitrate and/or at least a proportion of nitric acid. The mass composition may further comprise nitric acid in such a proportion that the pH of the aerosol is adjusted between less than or equal to 3 to greater than or equal to −1.

The mass ratio of nitrate anions to chlorides can be set to greater than or equal to 1:100, preferably greater than or equal to 1:60, further preferably greater than or equal to 1:30, further preferably 1:10 or even 1:1. Furthermore, the mass ratio of nitrate anions to chlorides can be set to less than or equal to 10:1, preferably less than or equal to 5:1, further preferably less than or equal to 1:1.

The mass ratio of metal compounds to anions can be set to greater than or equal to 1:1000, preferably greater than or equal to 1:300, further preferably greater than or equal to 1:100, further preferably greater than or equal to 1:50 or even greater than or equal to 1:10. Cumulatively or alternatively, the mass ratio of metal compounds to anions can be set to less than or equal to 1:3, preferably less than or equal to 1:8, further preferably less than or equal to 1:25, further preferably less than or equal to 1:75 or even less than or equal to 1:200

Moreover, the mass ratio of nitrogen-oxygen compounds to the chlorides can be set to greater than or equal to 1:200, preferably greater than or equal to 1:100, further preferably greater than or equal to 1:50, further preferably greater than or equal to 1:20. The mass ratio of nitrogen-oxygen compounds to the chlorides can also be set to less than or equal to 10:1, preferably less than or equal to 5:1, further preferably less than or equal to 1:1, and still more preferably less than or equal to 1:5.

The pH of the mass composition may be adjusted to less than or equal to 3, preferably less than or equal to 2.5 and further preferably less than or equal to 2. Further, the pH of the mass composition may be adjusted to greater than or equal to −1, preferably greater than or equal to −0.5, further preferably greater than or equal to 0.

The aerosol may comprise droplets or particles. In other words, the aerosol is a dispersion of solid and/or liquid suspended particles in an aerosol carrier gas, for example air or exhaust gas. The mass composition may, for example, be present in the condensed phase, so that the droplets or particles comprise the mass composition.

In a further embodiment, the chlorides can be present in the form of chloride anions and/or in dissolved or gaseous chloride compounds. The chlorides may comprise the element chlorine in the form of chloride anions and/or in at least one of the dissolved or gaseous states from the group consisting of atomic chlorine, elemental chlorine, hydrogen chloride, nitrosyl chloride, nitryl chloride or chlorine nitrate.

The self-activating photoactive aerosol according to the present disclosure can be used under the influence of artificial or natural radiation, such as light, preferably sunlight, for the degradation of methane and/or gaseous, vaporous or aerosol-form organic greenhouse-active organic substances. This is explained in detail with respect to the example embodiments. The underlying idea is to provide docking points for free methane or greenhouse gases or organic substances so that these substances can be deposited or captured in the aerosol and typically decompose.

For the production of a self-activating photoactive aerosol, for example according to the above description, preferably for the degradation of methane and/or gaseous, vaporous or aerosol-form organic greenhouse-active organic substances, a process is described comprising the following steps: Providing a first precursor with nitrate anions and/or nitrogen-oxygen compounds, providing a second precursor with chlorides, mixing the first and second precursors and adjusting a mass ratio in the range from 1 part nitrate anions and/or nitrogen-oxygen compounds to 200 parts chlorides up to 10 parts nitrate anions and/or nitrogen-oxygen compounds to 1 part chlorides to produce a chloride mixture aerosol, and moderating the pH in a range from less than or equal to 3 to greater than or equal to −1 (−1≤pH≤3).

The chloride mixture aerosol may further comprise metal compounds in the form of cations, molecules, oxides, hydroxides, particles and/or chemically bound elements, such as of iron and/or titanium, wherein the metal compounds may be present as iron chloride, iron nitrate, iron pentacarbonyl, titanium tetrachloride and/or titanium-containing hydrolysate of titanium tetrachloride. Furthermore, the chloride mixture aerosol may comprise a portion in condensed phase, for example droplets or particles.

The second precursor may comprise the chlorides in the form of chlorine compounds, for example at least one of chlorides, hydrogen chloride, chlorine, silicon tetrachloride, titanium tetrachloride, iron(III) chloride, iron(II) chloride.

Both the first precursor and the second precursor can therefore comprise metal compounds. In addition to the metal compounds already mentioned in the form of iron, titanium is also an obvious choice. This is because titanium is one of the ten most frequently occurring metals in the earth's crust of the subgroup elements in the periodic table alongside iron. Like iron(III), titanium(IV) is also photosensitive. Titanium is also non-toxic to ecosystems. When it absorbs sunlight, titanium changes its electron configuration in such a way that, for example, it breaks its bond with a hydroxyl group by absorbing a bond electron and, like iron, leaves behind the hydroxyl group as an ° ⁰H or OH radical. Hydroxyl radicals react with chloride ions to form chlorine atoms and hydroxyl ions; this is why titanium is also of interest for the new methane-degrading aerosol.

Titanium tetrachloride exhibits iron-like photocatalytic activity, and an aerosol containing it has strong albedo generating properties of titanium hydrolysates. It also has fewer toxic properties compared to soluble iron-containing aerosols. In addition, titanium tetrachloride is a liquid with a high vapor pressure that can be vaporized or atomized using nozzles. Hydrolysis with atmospheric moisture produces quantitative hydroxyl-containing titanium dioxide and hydrochloric acid mist. The TiO—HCl—H₂O₂ aerosols that are formed act as condensation nuclei for condensing nitric acid and/or ferric chloride and coagulate with the salt aerosol from seawater nebulization.

Silicon tetrachloride is therefore also a suitable HCl and condensation nucleating agent. SiO₂ does not undergo photolysis in the sunlight spectrum. However, SiCl₄ is also characterized by a similarly high sensitivity to hydrolysis as TiCl₄ and therefore tends to form nanometer-sized hydrolysis particles as a condensation nucleating agent and HCl supplier for pH adjustment or as a chlorine atom precursor. The hydrolysate aerosol formed from silicon tetrachloride hydrolysis also exhibits an albedo-generating property, for example.

Aluminum chloride is also suitable because of its ability to lower the ferric chloride sublimation temperature. AlCl₃ forms an AlFeCl₆ complex with FeCl₃, which has a higher vapor pressure than pure FeCl₃. The Al(OH)₃ formed during the hydrolysis of aluminum chloride in the aerosol is considered harmful to the ecosystem due to its toxicity to living organisms. However, this is completely compensated for by the formation of silicic acid, which is released from the hydrolysis of SiCl₄. Silicic acid or silicate forms the clay layer silicates containing aluminum and silicon with aluminum hydroxide. The layered silicate formation therefore starts immediately after the aerosol cloud is released, triggered by the air humidity. Clay formation is complete at the latest after the aerosols come into contact with the ocean. Aluminum nitrate can also be used to form the aerosol, especially when using the fogging systems.

The process described above can be supplemented with the step of mixing the chloride mixture aerosol with sulfur compounds, for example sulfur dioxide molecules, preferably gaseous sulfur dioxide and/or hydrogen sulfate, such as for moderating the pH value. Before the step of mixing the chloride mixture aerosol with sulfur compounds, the supplementary step of producing the sulfur compounds, for example the sulfur dioxide gas, can be carried out by burning elemental sulfur and/or by burning atomized liquid elemental sulfur with air.

In principle, the process can be carried out completely without the nebulization of a liquid component. Using only the nitrogen-, chloride- and metal-containing gas and vapor phases such as HCL, FeCl₃, SiCl₄, AlCl₃, TiCl₄, NOCl, NO₂Cl, HNO₃, preferably AlCl₃, FeCl₃, SiCl₄, AlCl₃ and/or TiCl₄ can form the liquid and solid condensed hydrolysates FeCl₃×nH₂O in contact with the carrier gas, which originates from the gas inlet for the vacuum pump, AlCl₃×nH₂O, SiOₙ(OH)ₘ, TiOₙ(OH)ₘ, in the form of nanoparticles, which are then formed as condensation nuclei for the condensation to liquid hydrochloric acid of the HCl formed by chemical reaction and hydrolysis, and the nitric acid formed by hydrolysis, oxidation and condensation from the nitrogen components. This ensures the formation of the “AquaRegia” aerosol. Although the pH value of this primary high-acid aerosol phase is still outside the optimum for photolytic chlorine atom formation, this changes in the atmosphere due to the further absorption of air humidity and coagulation with natural dusts, especially sea salt aerosols.

Immediately before the step of mixing the chloride mixture aerosol with the gaseous or vaporous first precursors, they can be generated by plasma-chemical conversion of air or evaporation of nitric acid. Before the step of mixing the chloride mixture aerosol with the gaseous or vaporous second precursors to provide the chlorine compounds such as hydrogen chloride, chlorine, ferric chloride, silicon tetrachloride, titanium tetrachloride, they can be generated by evaporation, electrolysis and/or chlorination. For example, this can be carried out in a mobile environment such as on a ship.

In the method, a chloride aerosol and/or an auxiliary gas can preferably be used in the step of mixing the chloride mixture aerosol. Further preferably, the step of mixing the chloride mixture aerosol may be carried out by atomization and/or by means of ultrasonic vibration, preferably under elevated atmospheric pressure. Alternatively or cumulatively, the step of mixing the chloride mixture aerosol may be carried out using a non-thermal nebulization process or a nebulization process by condensation and/or hydrolysis.

The step of mixing the chloride mixture aerosol can preferably be carried out using at least one mixing device such as a gas jet vacuum pump or a static mixer. Furthermore, the chloride mixture aerosol can be provided by nebulizing an aqueous chloride salt solution, such as additionally comprising nitrate anions, the chloride salt solution preferably having a salt content of 2% or more, or even 5% or more.

The yield of aerosol produced by the process can also be increased when a chloride-containing aerosol and/or vapors such as seawater aerosol, hydrogen chloride vapor, titanium tetrachloride vapor, silicon tetrachloride vapor or a ferric chloride aerosol as such or a chloride-containing aerosol and/or vapors which are present as mixtures of oxidic aerosols of the elements iron and/or titanium, is enriched (mixed) with one or more water-soluble inorganic vapor and/or gaseous reactants, for example nitrogen-oxygen compounds whose atomic ratio of oxygen to nitrogen (y) is equal to or greater than 1.5.

In the case of a precursor with an atomic nitrogen-oxygen ratio in the value range y<1.5, such as nitrogen monoxide (NO) with y=1, the reaction in the atmosphere by oxidation, hydrolysis and reaction with chloride salts to nitrate or nitric acid requires a considerable period of time, during which the methane degradation by the claimed aerosol does not take place or only takes place to a limited extent. Therefore, values for y≥1.5 are preferred. Atomic ratios of oxygen to nitrogen in the range of at least 1.5 (y≥1.5) are also referred to in this description as NO_{1,5+X}, in which case x≥0 applies. For example, the radical ° NO₃, the nitrate ion and the HNO₃ molecule assume the value x=1.5 in this case. The molecule N₂O₅ assumes the value x=1, for example. The NO molecule, for example, assumes the value x=−0.5. Nitrogen-oxygen compounds with x≤0.5, such as nitrous oxide (N₂O), are less preferred as precursors because their oxidation in the atmosphere is quite slow.

On the other hand, the closer the atomic ratio of oxygen to nitrogen y in the nitrogen-oxygen compound added to the chloride-mixed aerosol is to that of nitrate or nitric acid or corresponds to it, the greater the effectiveness of the chloride-mixed aerosol on the degradation of tropospheric methane or ozone. In other words, it could be shown in the context of the present disclosure that nitrates, nitric acid, hydrogen chloride and chloride cause the oxidation effectiveness of “Aqua Regia”; iron salts and titanium oxides can further increase its activity.

Alternatively or cumulatively to the nitrogen-oxygen compounds mentioned, one of the reactants from the group nitric acid, hydrogen chloride, aqueous hydrogen chloride solutions, hydrogen chloride-splitting compounds, aqueous ferric chloride solutions and aqueous ferric nitrate solutions can be converted to the claimed chloride mixed aerosol or ferric nitrate ferric chloride aerosol. The substances reacted by hydrolysis of hydrogen chloride-splitting compounds may comprise silicon tetrachloride, titanium tetrachloride, aluminum chloride; the compounds splitting off chlorine by hydrolysis of hydrogen chloride and/or by photolysis may comprise chlorine nitrate, nitryl chloride or nitrosyl chloride.

Among the nitrogen-oxygen compounds, ferric nitrate is considered an effective additive for accelerating these degradation reactions. A ferric nitrate aerosol is preferably enriched with the reactant hydrogen chloride or hydrogen chloride-releasing vapors.

The effectiveness of a ferric nitrate aerosol can therefore be increased with various other process variants, three of which are described below as examples:
a) that the ferric chloride aerosol particles or aerosol droplets are admixed with a gas, vapor or aerosol phase before, during or after their emission, which is characterized in that it preferably contains a nitrogen-oxygen compound whose atomic ratio of oxygen to nitrogen y is at least 1, preferably at least 1.5 or more. These include, for example, the substances ferric nitrate, sodium nitrite, nitric acid, nitrous acid, dinitrogen pentoxide, dinitrogen tetroxide, nitrogen trioxide, nitrogen dioxide, dinitrogen trioxide, nitrogen monoxide;
b) that the solution from which the ferric chloride aerosol particles or ferric chloride aerosol droplets are produced in a non-thermal nebulization process is preferably supplemented with one of the nitrogen-oxygen compounds mentioned by way of example under a), the atomic ratio of oxygen to nitrogen of which is at least 1, preferably at least 1.5;
c) that ferric nitrate aerosol particles or aerosol droplets are admixed with a gas phase before, during or after their emission, which is characterized in that it contains vaporized titanium tetrachloride.

A non-thermal fogging process can involve spraying ferric chloride solutions using nozzles, rotating brushes or ultrasonic vibrators. Thermal fogging processes use condensate droplet formation for aerosol formation, which is created by cooling the precursor, for example ferric chloride vapors.

An optimal effect of methane degradation by ferric chloride aerosol or chloride-containing titanium dioxide aerosol, to which the claimed effective nitrogen-oxygen compounds have been added, is in the range between pH 2 and pH 0.5. Moreover, the optimal catalytic effectiveness of catalysis is given for those nitrogen-oxygen compounds whose oxygen-to-nitrogen atomic ratio is 3 or more. These include, for example, nitric acid and its salts. The catalytic effect of ferric nitrate and its solutions is particularly outstanding. This also applies to dinitrogen pentoxide, which hydrolyzes to nitric acid or ferric nitrate in the presence of water, water vapor and ferric chloride.

Through disproportionation and/or hydrolysis, both salt-like and oxidic nitrogen-oxygen compounds can be transferred to an acidic pH value range of +3 to −1, and are present at least in part as nitric acid, and metal chloride can also be present in hydrolytic equilibrium with hydrochloric acid in an acidic pH environment.

The nitrogen-oxygen compounds (N—O compounds) are typically liquids, solids or gases with sufficient water solubility in the aerosol droplets and particles, which is also given under the preferably used acidic pH conditions. Due to the effectiveness of the addition of the N—O compounds to the aerosols containing ferric chloride on the degradation of the greenhouse gases mentioned, a catalytic acceleration by all N—O compounds can be assumed here. Consequently, the N—O compounds are to be described as catalysts. This designation is also justified because the proportion of N—O compounds present in the aerosol as well as the proportion of chloride in dissolved form remain effective in the “Aqua Regia” aerosols through continuous NO₂ and HCl recycling without degrading until they sink to the sea or land surfaces due to gravity. Even lower acidification reactions can occur there due to the necessary lower ferric chloride emissions. Both the alkaline pH values of the seawater surface and the alkaline components of the land surfaces, such as silicates and carbonates, ensure momentary neutralization at the moment of contact between ferric chloride aerosol droplets and the surface. Leaf surfaces of plants or the lung tissue of living organisms will not suffer any damage either, because the daily ferric chloride aerosol mass will be far below one milligram per m². Moreover, the aerosols are generally washed away by precipitation and therefore rarely come into direct contact with land and water surfaces during the aerosol phase. This also applies to the other chloride- and nitrate-containing aerosols claimed in the present disclosure containing at least one substance from the group hydrogen chloride, nitric acid, oxidic titanium and iron compounds, titanium hydrolysates and iron salts.

Of the options mentioned for adding N—O compounds, such as NO_{1,5+X}, to ferric chloride aerosols for the purpose of catalyzing ferric chloride photolysis to chlorine atoms, preference may be given to the addition of air according to process variant a), from the nitrogen and oxygen content of which the above-mentioned nitrogen and oxygen-containing activating agents have been generated in plasmas by means of electron impact reactions. The preferred activating agents nitric acid, dinitrogen pentoxide and nitrogen trioxide can be produced by such plasma-chemical reactions from air with the possible addition of water, possibly without the additional use of harmful chemicals.

By activating the air using a plasma process or a plasma reactor, air molecules are split and highly effective oxidizing agents such as atomic oxygen, hydroxyl radicals, ozone, nitrogen oxide, nitrogen dioxide, nitrogen trioxide and dinitrogen pentoxide are formed in the presence of moisture. Moisture is preferably enriched in the aerosol particles due to the hygroscopic ferric chloride. This is why the preferred nitrates or nitric acid are formed there. The formation of new ozone in the plasmas formed is harmless because this greenhouse gas is immediately destroyed by ferric chloride in contact with daylight.

Additions of 5 mol % ferric nitrate to ferric chloride can increase the methane yield by more than a factor of 10. Additions of 0.01 mol % dinitrogen pentoxide to 1 mol % ferric chloride can also increase methane degradation by more than 100%. If the molecular proportions of nitrate and chloride in the aqueous solution are in a ratio of 1 to 1, optimum methane degradation is obtained, which is a multiple of nitrate-free aerosol.

An undesirable result of the gases resulting from the plasma reaction may be an excessively high content of nitrogen-oxygen compounds whose molecular ratio of oxygen to nitrogen is less than 1.5 to 1, as is the case for NO and N₂O, for example. Nitrogen-containing gases with an oxygen to nitrogen ratio of <1.5 can be undesirable compared to other reactants because they can have a retarding effect on the photolysis of ferric chloride to chlorine atoms if they are present in excess. For this reason, gases, vapors and aerosols from plasma reactions with a low proportion of nitrogen monoxide are preferred.

The process described above (for the degradation of methane and other gaseous, vaporous and aerosol-form organic greenhouse-active organic substances and/or tropospheric ozone in the free troposphere and/or in volume fractions separated from the free troposphere by an extensive enclosure by photolysis of aerosol containing ferric chloride triggered by daylight and/or artificial irradiation) can thus be further improved in that aerosol particles or aerosol droplets containing ferric chloride are admixed with a further gaseous medium which contains one or more of the gaseous, vaporous and aerosol phases which are characterized in that they contain at least one oxygen-nitrogen compound in which the atomic ratio of oxygen to nitrogen (y) is preferably y≥1.5 to 1.

Alternatively or cumulatively, an improvement can be achieved if at least one component is added to the solution by means of which the ferric chloride aerosol particles or the ferric chloride aerosol droplets are produced in a non-thermal nebulization process, which component is characterized in that it contains N—O compounds in which the atomic ratio of oxygen to nitrogen y is greater than or equal to 1, preferably greater than or equal to 1.5 to 1.

The oxygen-nitrogen compounds with an atomic ratio of oxygen to nitrogen greater than or equal to 1.5 to 1 may be, for example, ferric nitrate, ferric nitrite, nitric acid, dinitrogen pentoxide, nitrogen trioxide, dinitrogen tetroxide, nitrogen dioxide, dinitrogen trioxide. To produce the oxygen-nitrogen compounds in which the atomic ratio of oxygen to nitrogen is greater than or equal to 1.5 to 1 and which are contained in a gas and/or aerosol and/or liquid phase, a plasma-chemical process can be used in which the oxygen and nitrogen molecules of the air are converted into the N—O compounds with the atomic ratio of oxygen to nitrogen y greater than or equal to 1, preferably greater than or equal to 1.5 to 1. The gas, aerosol or liquid phases, which are enriched with the conversion products, can be mixed with the ferric chloride solution to be nebulized and/or with aerosol containing ferric chloride.

The volume fraction of the atmospheric air that has been plasma-chemically converted to N—O compounds with the atomic ratio of oxygen to nitrogen y greater than or equal to 1, preferably greater than or equal to 1.5 to 1, is at least 1% by volume of the volume of air mixed and emitted with ferric chloride aerosol.

The emission of the aerosol cloud containing ferric chloride and N—O compounds with the atomic ratio of oxygen to nitrogen y greater than or equal to 1, preferably greater than or equal to 1.5 to 1, can be used prior to its emission into the free atmosphere under artificial irradiation with visible light and/or ultraviolet radiation within an enclosure to break down the methane content from a methane emission source, for example a coal mine or other methane emitter.

The process can be further developed by adding at least one substance from the group of seawater, organosulfur compounds, sulfur dioxide, diesel exhaust gas, plasma-chemically converted air, nitrogen-oxygen compounds to produce an “aqua-regia” precursor substance.

A cycle effect is described using the “Aqua-Regia” as an example. Hydrogen chloride vapor is formed in the atmosphere during the reaction of chlorine atoms with methane, which is recycled with the oxygen in the air and the nitrogen oxides produced during the photolysis of the “Aqua-Regia” aerosol to form the “Aqua-Regia” aerosol. This means that there is no loss of chlorine-atomic methane oxidizing agent as long as its precursor, the “Aqua Regia” aerosol, remains in the atmosphere and is not washed out of the atmosphere by precipitation.

The “Aqua-Regia” can be produced, for example, using emitted nitrogen oxide gases as a carrier gas. The aerosol embedded in the carrier gas can be provided by nebulization of an aqueous alkali and/or alkaline earth chloride solution, which may contain nitrate. Atmospheric oxidation and hydrolysis of the sulfur dioxide to sulfuric acid and of the nitrogen oxides to nitric acid converts the chloride aerosol into an aerosol containing hydrogen sulphate and “aqua regia”.

The use of iron-free “aqua regias” for methane oxidation has the benefit over iron-chloride aerosols that no emission of soluble or dissolved metals such as iron salts is required. This has the further benefit that no precipitation of ochre-colored iron compounds is caused. Depending on the area of application—e.g., over icy areas such as the polar ice caps—this can be undesirable or desirable if it has a positive effect on natural cycles. This can be weighed up depending on the area of application. Both hydrogen chloride and nitric acid are known to be natural components of the atmosphere, which can occur in volcanic ash and sea salt aerosols, for example. However, the addition of one or more metal compounds, such as transition metal compounds such as iron and/or titanium, to the atomized acidic nitrate and/or chloride aerosol can increase the effectiveness of the resulting “aqua regia” for methane degradation and, as a result, represent a good compromise between metal-containing aerosols without “aqua regia” components and metal-free aerosols, since the effectiveness is increased compared to both of the aforementioned aerosols and, overall, only requires a lower emission of metal components in relation to each degraded methane molecule.

Instead of or in addition to the nitrate content in the nebulized aqueous alkali and/or alkaline earth nitrate and chloride solution mixture, a proportion of the nitrate or even the entire nitrate content can be replaced by plasma-chemical conversion of air to gaseous and/or vaporous N—O compounds, which are added to the aerosol carrier gas in addition to or instead of sulfur dioxide. After atmospheric oxidation and hydrolysis with the water-containing aerosol, nitric acid and nitrate are formed on the aerosol droplets or particles formed. Accordingly, the corresponding proportion of sulfur dioxide can be reduced in order to ideally adjust the pH environment of the resulting aerosol between 0 and +2.

Sulphur combustion is the preferred SO₂ source. The combustion heat of sulfur combustion allows the process to be carried out at a higher temperature if necessary. Seawater is the preferred source of chloride. Plasma-chemically converted air is the preferred source of nitrate.

In the event that the components of the “Aqua-Regia” aerosol are immitted from the atmosphere in sufficiently low concentrations, they can therefore do no harm, as their acid concentration is diluted to pH values>4 by the precipitation water and neutralization processes take effect immediately after they hit the ground or ocean surface.

In addition, the small traces of nitrate fertilizer produced increase the production of organic carbon by phytoplankton. However, they are probably not sufficient to trigger harmful algal blooms. In addition, the increased conversion of bicarbonate to organic carbon by the phytoplankton triggers the formation of basic carbonate, which neutralizes the acidity of the washed-out “Aqua Regia” aerosol. Moreover, the specific quantities immitted daily from the atmosphere can thus be limited to an average of less than 1 mg/m² of ocean surface and are therefore generally lower than any naturally occurring aqua-regia emissions, which are triggered by volcanic ash eruptions, for example.

Sulphate and accompanying cations from the group of alkalis and alkaline earths are among the essential components of sea salt. They are therefore also not toxic or ecosystem-damaging emission components.

The investigation has shown that methane degradation during the day also occurs with diluted aqueous “Aqua-Regia” solution at pH values of 2 and below. The addition of SO₂ and/or NOₓ can be calculated in such a way that the resulting acid formation is sufficient to transfer the aerosol particles and/or aerosol droplets to a pH range between +2 and −1, for example, as they already have sufficient capacity for methane oxidation.

When converting a neutral nitrate-chloride aerosol, it is sufficient that the SO₂ and/or NOₓ gas concentration in the aerosol cloud is such that there is one SO₂ and/or NOₓ molecule for each anion in the nitrate-chloride aerosol. Through oxidation and hydrolysis of the aerosol SO₂ and/or NOₓ cloud composed in this way, the chloride-nitrate aerosol is subsequently converted into an acidic chloride-nitrate aerosol with a pH value of −1, which incidentally has the property of a diluted “AquaRegia”. It has been shown that the sensitivity of the photolysis of the diluted “AquaRegia” is not influenced by the pH value, as long as the pH value in the “AquaRegia” aerosol does not rise to values above 3, preferably not above 2. Thus, SO₂ additives are acceptable if the molar ratio of SO₂ to anions is set between 0.8 and 1.5. Incidentally, the term “AquaRegia” is also retained for the weakly concentrated HCl—HNO₃ mixture (solid or liquid aerosol particles) because the same oxidation mechanism is obviously at work here during methane oxidation, regardless of the pH value difference between the concentrated “Aqua-Regia” acid, which has a pH value of below −1, and the diluted “Aqua-Regia” acid, which has a pH value of around +2, for example.

The methane-degrading effect of “Aqua-Regia” triggered by sunlight is based on nitric acid photolysis to nitrogen dioxide and hydroxyl radicals. The hydroxyl radicals oxidize chloride to chlorine atoms.

If the pH value of the “Aqua-Regia” is not raised above pH +3, preferably +2, for example due to a deviation in the ratio of nitric acid to hydrochloric acid from the classic ratio of 1 to 3, the acid-forming hydronium ions can be partially replaced by other cations, such as alkali and/or alkaline earth ions. Oxidation and hydrolysis of the nitrogen dioxide formed by the photolysis in the atmosphere will also restore the nitric acid, so that the emitted “AquaRegia” aerosol cloud, as long as it exists in the atmosphere, continuously regenerates itself, preferably largely independently of the prevailing methane concentration.

The “Aqua-Regia” aerosol is produced, for example, by condensing vaporous mixtures of hydrogen chloride, nitric acid and water, possibly by excitation with condensation nuclei generated in situ, e.g., from hydrolyzed aerosolized silicon tetrachloride or titanium tetrachloride, or by mixing vaporous hydrochloric acid with aerosolized nitric acid, or vice versa from vaporous nitric acid with hydrochloric acid aerosol. It can also be done by nebulizing liquid “Aqua Regia” aerosol. In other words, an HCl—HNO₃—H₂O mixture aerosol can be provided.

The “Aqua Regia” components HCl, HNO₃ and H₂O as such or in the form of their oxidizing radicals and atoms ° H, ° Cl, ° NO₂, ° NO₃ formed in electromagnetic radiation (light such as sunlight) or the reaction products Cl₂, HOCl, NOCl, NO₂Cl and NO₃Cl photolyzing in sunlight itself can act in the homogeneous gas phase in which the methane molecules are also present. They can therefore react with the methane there and continue to break down methane via the cyclic processes discussed.

A ferric chloride aerosol as a precursor is comparatively more reactive than the cascade of oxidizing agents triggered by the “aqua regia” through photolysis, which can be further activated by the photosensitive components ferric chloride and/or oxic titanium compounds, all of which ultimately end in the formation of ° Cl before it is hydrogenated to HCl in the methane reaction.

Sulphur dioxide can be produced by burning organosulfur compounds. It is therefore possible to utilize the combustion exhaust gases of sulfur-rich oils from marine diesel engines for the claimed process. These exhaust gases also contain the gaseous nitrogen oxides NO and NO₂, which can also be used because they are converted to nitric acid by hydrolysis and oxidation in the atmosphere, for example by being converted into the “Aqua Regia” aerosol with seawater aerosol and the sulfuric acid produced from the SO₂.

Air can also be used as a nitrate precursor, which is converted to nitrogen oxides by plasma-chemical conversion in discharge plasma or microwave plasma-chemical processes, e.g., into the gaseous and vaporous NOₓ compounds NO, NO₂, NO₃, N₂O₄ and N₂O₅. In this description, “NOₓ” is used in particular for the oxygen-containing nitrogen compounds that can change into nitrate and/or nitric acid in the atmosphere through hydrolysis and/or oxidation. Through atmospheric oxidation and/or hydrolysis in the aerosol cloud, these oxygen compounds of nitrogen in the atmosphere are ultimately converted to nitric acid and nitrate with the aerosol droplets or particles to form the “Aqua Regia” aerosol.

Those new processes for the direct production of nitric acid or nitrates by electrochemical N₂ oxidation in the electrolysis cell or by primary N₂ reduction in the electrolysis cell to ammonia or NH₃ and their subsequent catalytic oxidation to nitric acid are also suitable as an environmentally friendly basis for the production of the claimed “Aqua Regia” aerosols.

Instead of nitric acid, gaseous and/or vaporous nitrogen oxides can also be used, which form nitric acid through oxidation in the atmosphere and hydrolysis. It is also possible to use elemental chlorine instead of hydrochloric acid. This forms chlorine-containing nitrogen-oxygen compounds with nitrogen oxides, which can also form “aqua-regia” aerosols through photolysis and hydrolysis.

The use of gaseous and vaporous “Aqua-Regia” precursors such as nitrogen-oxygen compounds, hydrogen chloride, chlorine and vaporous chlorides containing silicon and titanium has the benefit of less complex corrosion protection. For this reason, the mixing and/or conversion of an “Aqua-Regia” precursor to “Aqua-Regia” aerosol is also placed close to the outlet point of the “Aqua-Regia” aerosol. Preferably, the gaseous and vaporous “Aqua-Regia” precursors N—O compounds are produced by treating air by means of known processes using electromagnetic waves or electrical discharges by plasma chemical reactions (plasma reactor).

In principle, the methane-degrading “AquaRegia” aerosol presented here and its gaseous, vaporous and aerosol precursors can therefore be generated on diesel engine-powered ships by using only the slightly alkaline chloride salt-containing seawater as an aerosol precursor and NOₓ gases or vapors from the air through plasma synthesis and the SO₂ and NOₓ from the ship's engine exhaust gas, completely without the use of purchased chemicals.

Only after sufficient atmospheric chemical conversion of sulfur dioxide to sulfuric acid and of NOₓ in the atmosphere to nitric acid and the reaction of these substances with the chloride aerosol from seawater does the conversion to “Aqua Regia” aerosol finally take place and methane degradation by sunlight photolysis can begin. A metal compound such as ferric chloride, ferric nitrate, ferric nitrite and/or titanium tetrachloride is added to the atomized salt water or seawater in order to optimize methane degradation and/or the degradation of incompletely combusted hydrocarbons as well as soot and smoke particles by “Aqua-Regia” aerosols. Ferrous salts from the group of chlorides, nitrates and nitrites can also be used for this purpose. Preferably, a ferrous nitrate or ferrous chloride is added to the chloride solution to be nebulized, which preferably consists of or comprises filtered seawater, because ferrous salts have a lower tendency to hydrolyze.

Sunlight photolysis of an acidic metal salt aerosol containing nitrate and chloride increases the effectiveness of the “Aqua-Regia” oxidation effect, because initially both the elemental chlorine released from the “Aqua-Regia” reaction and the metal chloride release chlorine atoms through photolysis under the influence of sunlight. Sunlight photolysis of ferric nitrate to ferrous nitrate, in which nitrogen trioxide radicals are formed, which are converted into nitric acid and hydroxyl radicals during hydrolysis, can also increase effectiveness. The latter oxidize hydrogen chloride and chloride ions to chlorine atoms.

The first precursor may comprise at least one substance from the group consisting of metal nitrate, metal nitrite, iron nitrate, iron nitrite, titanium dioxide, hydrolysis product of titanium tetrachloride, nitric acid, NO, NO₂, NO₃, N₂O₃, N₂O₄, N₂O₅. Alternatively or cumulatively, the atomic ratio between oxygen and nitrogen in the first precursor may be set greater than or equal to 1, preferably greater than or equal to 1.5 to 1. Further alternatively or cumulatively, the second precursor may comprise chlorine compounds, such as at least one of hydrogen chloride, chlorine, metal chloride, ferric chloride, silicon tetrachloride, titanium tetrachloride.

The second precursor can be provided in the form of a hydrogen chloride vapor and/or comprise metal chloride, for example one or more metals from the group silicon, titanium, aluminum, for example as chlorides in the form of SiCl₄, TiCl₄, AlCl₃, or the aerosols from aqueous chloride solutions such as seawater and ferrous chloride dissolved therein.

In the step of providing the first precursor, the use of a plasma chemical process and/or a plasma reactor may be indicated to generate a plasma from atmospheric air. The use of a plasma-chemical process and/or a plasma reactor may be used e.g., to generate the oxygen-nitrogen compounds from the oxygen and/or nitrogen contained in the atmospheric air.

In the plasma-chemical process, for example, a non-thermal plasma can be generated or maintained, such as plasma glow discharge, corona discharge, silent electrical discharge with or without water contact, capacitive or inductive high-frequency discharge, microwave discharge, dielectrically impeded discharge, air plasma jet with water contact, or sliding arc discharge with water contact, whereby the process can be carried out e.g., under vacuum or under atmospheric pressure. A high-temperature plasma can also be generated or maintained in the plasma-chemical process.

A volume fraction of the first precursor produced by the plasma chemical process and/or the plasma reactor can preferably be 1 vol % or more, for example 2.5 vol % or more or 5 vol % or more, of the self-activating photoactive aerosol to be produced.

With the use of a plasma reactor, the yield of chlorine atoms can be increased by photolysis of iron(III)chloride aerosols by adding plasma-activated air to the aerosol. Plasma” can be understood as the splitting of neutral molecules into negative and positive ions in the neutral medium of air by adding energy. This occurs, for example, by electron impact reaction. For economic reasons, “cold” processes are preferably used for this purpose. Overall, there is an economic benefit in that the chlorine atom yield can be increased by adding the activated air. The greenhouse gas and aerosol content of the troposphere, such as methane, which contains organic substances and elemental carbon, can be broken down more efficiently as a result.

NO_{1,5+X}-reactants for which x≥−0.5 applies can be used as the gas and/or vapor phase. Preferred are those NO_{1,5+X} reactants for which X≥0.5 applies, further preferably x≥1.0, or x=1.5. These are substances such as dinitrogen pentoxide (e.g., in vapor form), or nitric acid, which form nitric acid and ferric nitrate during hydrolysis with water-containing aerosol particles, e.g., forming the same directly, unlike NO₂, for example. Such NOₓ reactants can be generated from atmospheric air by electron impact-induced reactions in which gas plasmas containing ionized and/or energy-rich atoms or molecules are formed, which are suitable for the claimed process. The plasmas that can be used for the claimed process can be divided into high-temperature and low-temperature plasmas. High-temperature plasmas are formed during electrical spark discharges.

The glow discharge is preferably carried out in a vacuum at <10 mbar and is therefore well suitable for iron(III)chloride aerosol production processes in which aerosol production is carried out using a vacuum. Corona discharge and also silent discharge can be carried out at atmospheric pressure. Capacitive and inductive high-frequency discharge as well as microwave discharge can be carried out at both vacuum and atmospheric pressure.

By activating the air with the processes mentioned, air molecules are split and highly effective oxidizing agents such as atomic oxygen, hydroxyl radicals, ozone, nitrogen oxide, nitrogen dioxide, nitrogen trioxide and dinitrogen pentoxide are formed. The formation of chlorine atoms per metal equivalent emitted can thus be increased compared to known processes; conversely, this means that fewer iron salt aerosols have to be emitted to achieve the same chlorine atom effect or the same methane degradation.

The photolysis of iron(III)chloride aerosols to chlorine atoms can therefore be activated by the addition of air activated by plasma formation in such a way that the chlorine atom yield is increased. Additions of just 1 to 5 volume fractions of plasma-activated air in relation to 100 volume fractions of the air volume mixed with and emitted from the iron(III)chloride aerosol increase the chlorine atom yield by more than 100%.

The process described above (for producing chlorine atoms in the troposphere) can therefore be improved by emitting an aerosol containing iron(III)chloride in a mixture with plasma-activated air (into the troposphere). The volume fraction of the added plasma-activated air is desirable at least 1% by volume of the volume of air mixed and emitted with iron(III)chloride aerosol.

In the step of providing the second precursor, it may be preferable to use a sublimation device for a fluidized bed. Here, a process can be used that improves the vapor yield at a reduced temperature, namely the sublimation of starting material from a moving bed and/or a fluidized bed with the aid of a hot carrier gas. The movement of the solid bulk material to be sublimated in the moving bed can be triggered mechanically by vibration and/or stirring, for example. In the case of the sublimation of iron(III)chloride, it is helpful if the carrier gas is inert. Gases such as CO₂ or N₂ are suitable as a swirl medium. The carrier gas continuously removes the iron(III)chloride vapor from the surfaces of the solid iron(III)chloride starting materials and thus reduces the iron(III)chloride vapor pressure above the sublimating starting materials. This effect increases the sublimation rate of ferric chloride or allows the same sublimation rate at a lower temperature. The generation of the vapor phase as such in the fluidized bed by sublimation of solid particles was proposed, for example, by the company Kemstream, Montpellier, France. However, the undesirable result of this sublimation method is the high consumption of carrier gas.

The pile bed proposed herein consists of or comprises preferably anhydrous ferric chloride. The pile bed may be characterized in a preferred manner by at least one of the following features:
a mixing device providing at least one of the movements stirring, vibrating, shaking, circulating, fluidizing by means of inert gas flow,
providing the mixing device with grinding aids, such as ceramic balls,
an evacuation facility,
a gas flow system for providing an inert gas for flowing through the pile bed, whereby the inert gas can be heated or unheated,
a heating device for heating the pile bed, that may be a directly heated ferric chloride pile bed, which may be directly heated by means of one or more heaters from the group of heat transfer medium flow-through thermostatized tube heating, infrared radiation, microwave heating,
a temperature control device for controlling the temperature in the ferric chloride pile bed between 10° and 220° C., preferably 140 to 200° C.

Vacuum operation of the sublimation device is preferred in order to ensure operation at lower temperatures. This allows the temperature to be kept below 200° C., as undesirable side reactions can occur above 200° C.

The evaporation rate of the sublimation can be increased if the sublimating metal chloride is placed in a heated fixed bed of small-particle to powdery bulk material, which is moved by means of one or more measures such as stirring, vibrating or shaking and through which a gas flow, for example of inert gas such as CO₂ and/or N₂, passes. It is helpful to use grinding aids such as ceramic beads, which constantly create new fracture surfaces in the crystalline ferric chloride in the fixed bed as it moves through and thus increase the evaporating surfaces. By using ferric chloride in a mixture with aluminum chloride to produce the moving bed to be sublimated, the sublimation temperature of ferric chloride can be reduced, as the FeAlCl₆ molecules, which sublimate at a lower temperature, form instead of the Fe₂Cl₆ molecules in the vapor phase.

The mixing of the first and second precursors with each other can also be carried out in a partially enclosed environment, for example an enclosure such as a chimney or exhaust pipe. Alternatively or cumulatively, after the step of mixing the first and second precursors, the mixed self-activating photoactive aerosol can be ejected, for example using a pressurized gas.

The ejection of the mixed self-activating photoactive aerosol can preferably be carried out from at least one of the following delivery locations: Ship, floating platform, oil rig, airplane, balloon, blimp, cooling tower, smokestack, exhaust, lattice tower, mountaintop.

In one aspect, a method is described for generating iron(III)chloride aerosol plumes in the troposphere consisting of aerosol particles and/or droplets containing iron(III)chloride from sublimated vaporous iron(III)chloride, wherein the aerosol particles are generated by physical and chemical condensation by mixing with a gas jet. This process may be characterized by one or more of the following:
I) Reducing pressure of the sublimation chamber with a pressure below ambient pressure (=“negative pressure”) from at least one gas jet vacuum pump,
II) Movement of the sublimation bed of anhydrous iron(III)chloride pieces in the sublimation chamber without using the usual fluidized bed movement method,
III) Comminution of the starting material from anhydrous iron(III)chloride pieces in the sublimation chamber by moving grinding media,
IV) Use of one or more gas jet vacuum pumps as devices in which the jet gas is mixed with the iron(III)chloride vapor,
V) Use of ferric chloride in a mixture with aluminum chloride in the provision of the moving bed to be sublimated to reduce the sublimation temperature.

A method for generating aerosol plumes in the troposphere comprising aerosol particles and/or droplets containing ferric chloride from sublimated vaporous ferric chloride, and wherein the aerosol particles are generated by physical and chemical condensation by mixing with a gas jet, may be improved by one or more of the following additional measures:
I) Reducing pressure of the sublimation chamber with a negative pressure from at least one gas jet vacuum pump,
II) Movement of the sublimation bed of anhydrous iron(III)chloride feedstock in the sublimation chamber without using the usual fluidized bed movement method,
III) Comminution of the starting material from anhydrous iron(III)chloride in the sublimation chamber by moving grinding media,
IV) Use of one or more gas jet vacuum pumps as devices in which the jet gas is mixed with the ferric chloride vapor,
V) Use of ferric chloride in a mixture with aluminum chloride in the preparation of the moving bed to be sublimated to reduce the sublimation temperature.

In large stationary off-shore or on-shore emission systems for the provision of “Aqua-Regia” aerosols, the gas jet vacuum pump may be driven by a turbine jet engine. It may also provide that the movement of the iron(III)chloride bed is realized by one or more of the following motions: Shaking, vibrating, grinding or stirring.

In such a process, the grinding media can be glass and/or ceramic beads. These grinding media or grinding beads can preferably have a diameter of between 1 mm and 30 mm.

The pressure drop generated above and inside the sublimation bed can lead to a pressure of less than 200 mbar, preferably less than 20 mbar. The temperature range within the sublimation chamber and within the moving bed can be, for example, 100 to 250° C., preferably 150 to 210° C.

The carrier gas jet can preferably be provided by a turbine engine, which can, for example, be arranged so that it ejects vertically upwards.

In addition to its use as a ferric chloride vapor generator, the ferric chloride vapor generator can also be used to vaporize the low-boiling tetrachlorides of silicon and titanium. These liquids can be fed individually or as a mixture into the ferric chloride sublimation chamber, where they are preferably evaporated below the ferric chloride bed. As it passes through the sublimation chamber, the vapor generated in the process passes through the ferric chloride bed and acts as a ferric chloride vapor-removing carrier gas.

With a process as described on the preceding pages, it is possible to substantially increase the yield of chlorine atoms by adding an iron(III)salt, preferably as chloride and/or nitrate, or an oxic titanium compound to a solution mixture, which preferably contains chloride and nitrate from the same molecular constituents and from which the aerosols are produced, in a concentration by weight, based on the solids present in the solution, of between preferably 1% and 90% iron salt and/or titanium oxide content. For example, the salt and acid content of the aerosols may comprise at least 1 nitrate weight fraction based on 6 chloride weight fractions and contain at least 0.1 weight fractions each of iron and/or titanium.

An economic benefit of the processes presented here is that the chlorine atom yield can be increased by more than 100%. The greenhouse gas and aerosol content of the troposphere containing organic substances and elemental carbon—especially methane—can be reduced by processes that trigger the release of chlorine atoms into the atmosphere. Compared to previously described processes, the formation of chlorine atoms per emitted iron equivalent can be increased. This means that fewer iron salt aerosols have to be emitted in order to achieve a similar effect of chlorine atoms in the atmosphere or the same methane degradation. If necessary, iron additives in the aerosol can be avoided, or completely dispensed with. This opens up new and wider areas of application for the chloride mixed aerosol presented here. Previously described ferric chloride aerosols, for example, cannot be used in the vicinity of albedo-effective snow and ice fields, or only with difficulty, because the colored ferrite compounds directly reduce the reflection and, due to their trace element effect, also promote the albedo-reducing spread of algae and mosses on the snow and ice surfaces. The reduction in the use of iron, or even the complete replacement of iron with photosensitive nitric acid, nitrate and titanium oxides, now also enables the use of atmospheric methane degradation in the immediate vicinity or even on these albedo-effective and thus climate-cooling ice surfaces. Nitrate and nitric acid do not have a fertilizing effect here because these photosensitive substances are subject to degradation by solar radiation. On the other hand, the white oxidic titanium compounds even directly and sustainably increase the return radiation, because dark precipitation from soot and smoke aerosols, including algae, biofilms and mosses that have grown there, can be “burned away” by the hydroxyl radical formation through the titanium oxides.

As part of the process presented here, it is possible to nebulize aqueous solutions containing acidic mixtures of iron(III)nitrate and chloride salts into aerosols and emit them into the ambient air. Photolysis in daylight leads to an increased formation of chlorine atoms compared to nitrate-free iron(III)chloride aerosol. Even with the complete exclusion of iron in the nebulized chloride and nitrate solution, chlorine atoms are formed if the solution is acidic, as is also claimed. It is preferable to have at least a small amount of metal such as titanium and/or iron in the aerosol, as this promotes the formation of chlorine atoms compared to the metal-free solution. Optimal chlorine atom formation was observed at pH values between 2.5 and 0.5.

If the chloride-nitrate salt solution used for nebulization has been given a recognizable color by the addition of iron(III)salt, improvements in chlorine atom formation from the aerosols can be expected. Coloration is already clearly visible visually at iron(III)concentrations in the chloride-nitrate solution between 1 and 5%. This is clearly visible at a weight proportion of the aqueous solution of 5% and increases to a maximum when the cation proportion of the iron(III) is 100%.

The use of iron(II)salts can also promote the formation of chlorine atoms, probably because the oxidizing effect of the atmosphere acts on the aerosol to convert iron(II) to iron(III).

Preferably, the molecular proportions of nitrate and chloride are contained in the aqueous solution in a ratio of about 1:10 to about 1:1 in order to obtain a sufficient chlorine atom yield. A nitrate to chloride weight ratio of about 1:2 to 1:4 is preferred. Photolytically generated chlorine atoms act in a known manner on atmospheric methane as an oxidizing agent and trigger its degradation to methyl radicals by hydrogen removal with methyl radical formation. Hydrogen chloride is absorbed by the aerosols with salt reformation and is thus “recycled”. The same happens with nitrate, which is reduced to NO₂ in the course of the reaction and, after absorption by the aerosol particles and oxidation, is recycled back to nitrate and thus to salt formation.

It is desirable to produce aerosols for chlorine atom generation by nebulization whose aerosol particles have a diameter of less than 1 μm in order to optimize their productivity. If nebulization is used, the yield of aerosol particles with a diameter of less than 1 μm can be increased by the evaporation of water from the aerosol droplets in the atmosphere if sufficiently dilute solutions are used for nebulization, e.g., filtered seawater. In other words, water can be added to the first and/or second precursor to reduce the diameter of the aerosol particles.

Instead of releasing the claimed salt solution mixtures as aerosols in the free atmosphere, these salt solutions can also be used inside enclosed and artificially irradiated spaces, for example to break down methane emissions from defined sources—such as a coal mine, a pump head of a natural gas well, or artificial methane sources. Suitable locations for the release of the aerosols into the troposphere are also the more or less completely enclosed spaces of upwind systems, such as the so-called upwind power plants.

In the process described above, for example to provide chlorine atoms in the troposphere, an aqueous solution mixture can be nebulized in a reaction chamber such as the troposphere. It preferably contains the ions chloride, nitrate and possibly also iron(III)cations and/or hydroxyl-containing titanium-oxygen compounds contained as a suspension.

In a further embodiment, the iron(III) and/or the hydroxyl-containing titanium-oxygen compounds in the aqueous solution can have a weight proportion of the cations contained therein of at least 1% and at most 100%. The molecular proportions of nitrate to chloride can be contained in the aqueous solution in a ratio of 1:10 to 1:1. The solution mixture may also contain iron(II).

Finally, a possibility for generating the claimed aerosol, referred to as variant 4, is also proposed, according to which both the metal chloride reactant and the metal nitrate reactant are transferred separately into the aerosol phase and then the two aerosol phases are transferred into the claimed aerosol by mixing them together. The undesirable result of this variant is that the aerosol particles and droplets only coagulate with each other very slowly. However, since their hydrogen chloride and nitric acid components have a considerable vapor pressure in the pH range of 2 and less than 2 required for optimum methane conversion, the formation of the claimed ferric chloride-ferric nitrate mixture can also occur without particle or droplet coagulation, albeit with a delay.

The present description also appreciates a device for providing a self-activating photoactive aerosol, for example as described above. Preferably, the apparatus is for carrying out the method described above. The apparatus comprises a reaction chamber, a first device connected to the reaction chamber, in particular a NOx device, for providing a first precursor comprising nitrate anions and/or nitrogen-oxygen compounds in the reaction chamber. The apparatus further comprises a second device, such as a chloride device, connected to the reaction chamber for providing a second precursor comprising chlorine or chlorides in the reaction chamber.

A carrier gas supply device is used to provide a carrier gas in the reaction chamber. For example, a compressed gas that can be provided by a compressor can be used as the carrier gas. Exhaust gas can also be used as the carrier gas.

The device is designed to bring about a mixture of the first and second precursors in the reaction chamber and to set a mass ratio in the range from 1 proportion of nitrate anions and/or nitrogen-oxygen compounds to 200 proportions of chlorides up to 10 proportions of nitrate anions and/or nitrogen-oxygen compounds to 1 proportion of chlorides. In addition, the device is designed to moderate the pH value in a range from less than or equal to 3 to greater than or equal to −1 (−1≤pH≤3).

The device can be further designed in that the first device comprises a plasma reactor for generating a plasma from atmospheric air, e.g., for generating the oxygen-nitrogen compounds from the oxygen and/or nitrogen contained in the atmospheric air.

The plasma reactor of the device may generate or maintain a non-thermal plasma. For example, the plasma reactor comprises or performs one of the following processes: Plasma glow discharge, corona discharge, silent electrical discharge with or without water contact, capacitive or inductive radio frequency discharge, microwave discharge, dielectrically impeded discharge, air plasma jet with water contact, or sliding arc discharge with water contact.

The plasma reactor can be operated under vacuum or atmospheric pressure. If necessary, the plasma reactor can provide or maintain a high-temperature plasma.

The carrier gas supply device may preferably comprise at least one of the following features: a gas jet, a pressurized gas system, or a suction device. Alternatively or cumulatively, the device may be arranged so that the first device is connected to the reaction chamber via a NOx outlet. The second device can be connected to the reaction chamber via a chloride outlet. The device can also be designed so that the NOx outlet and the chloride outlet open into the reaction chamber as a common NOx/chloride outlet, i.e., the first device and the second device are connected to the reaction chamber via the common NOx/chloride outlet.

The device may comprise an atomization unit and/or an ultrasonic vibration unit, a nebulization unit, such as for carrying out a non-thermal nebulization process and/or a nebulization process by condensation and/or hydrolysis, a metal chlorination unit, for example for iron chlorination, a mixing device such as a gas jet vacuum pump and/or a static mixer, which is arranged, for example, in or on the reaction chamber.

In a preferred embodiment, the second device can comprise a sublimation device for a pile bed. For example, the pile bed may comprise or consist of anhydrous ferric chloride. The pile bed may further be characterized by at least one of the following features: a mixing device providing at least one of the movements stirring, vibrating, shaking, circulating, fluidizing by means of inert gas flow; grinding aids, such as ceramic balls, providing the mixing device; an evacuation device; a gas flow device for providing an inert gas for flowing through the pile bed; a heating device for heating the pile bed; a temperature control device for controlling the temperature in the ferric chloride pile bed between 10° and 220° C.

The device may further comprise a steam generator for generating a nitrate vapor by feeding air and HNO₃ into the steam generator at elevated temperature and/or pressure. In a further embodiment, the device may alternatively or cumulatively comprise a vapor generator for generating a chloride vapor by feeding air and HCl into the vapor generator at elevated temperature and/or pressure. In other words, a steam generator can be used to generate a nitrate vapor or chloride vapor or even a nitrate-chloride mixed vapor. However, nitric acid and hydrochloric acid already have a certain corrosion potential in themselves. In order to limit the effects of corrosion, other alternatives for this device component are therefore also being discussed, such as the plasma reactor, with which NOₓ reactants can be produced directly in the gas or vapor state.

The fogging system may comprise nozzles, rotating brushes, or an ultrasonic vibration generator for generating a nitrate fog by feeding liquid metal nitrate into the fogging system, and/or for generating a chloride fog by feeding liquid metal chloride into the fogging system, and/or for generating a nitrate-chloride fog by simultaneously feeding liquid metal nitrate and liquid metal chloride into the fogging system.

In a preferred form, the second device can comprise a reaction device for the exothermic reaction of metal compounds, i.e., metals or metal alloys, with chlorine gas. The metal compounds used can be, for example, metallic iron, silicon, titanium or aluminum. To control the temperature in the conversion device, a temperature control device can be provided for control in the preferred range between 450° C. and 600° C. For example, a metal that has preferably been crushed or preformed into coarse particles or pellets can be converted exothermically with a small excess of chlorine gas. Any decomposition reactions of ferric chloride to ferrous chloride are suppressed by a slight excess of chlorine. Any subsequent low chlorine content in the emitted ferric chloride aerosol cloud is photolytically broken down into chlorine atoms and immediately incorporated into the HCl-ferric chloride recycling cycle of the ferric chloride aerosol cloud by reaction with methane.

The device as described above may be designed to deploy the device on one of the following deployment sites: ship, floating platform, oil rig, airplane, balloon, blimp, cooling tower, chimney, exhaust pipe, lattice tower, mountain top, upwind power plant, turbine.

The reaction chamber can be arranged in an enclosure with an outlet for releasing the self-activating photoactive aerosol. Preferably the reaction chamber can be arranged in a cooling tower, chimney, exhaust pipe, lattice tower, updraft power plant or turbine. Reactant vapors and/or gases, i.e., first and/or second precursor, such as from the NOₓ plasma reactor and from the evaporator, vapor and aerosol condensing therefrom from the ferric chloride sublimator or from the iron-chlorine gas reaction as well as reactant aerosols from the non-thermal nebulization (depending on which components of the device are used) are predominantly converted into the claimed acidic mixed aerosol by reaction in the turbulence zone arranged in the reaction chamber. The aerosol is then typically emitted into the atmosphere.

The present description also defines an exhaust gas treatment plant for at least partially converting exhaust gases and simultaneously providing a self-activating photoactive aerosol, for example as described above, and/or for use, for example, under a process as described above. The exhaust gas treatment apparatus comprises a reaction chamber arranged in a pipe section prepared for exhaust gas discharge, for example in an exhaust pipe or chimney; a first device for providing a first precursor comprising nitrate anions and/or nitrogen-oxygen compounds in the reaction chamber; a second device for providing a second precursor comprising chlorides in the reaction chamber; an exhaust gas emitter, such as a diesel engine, as carrier gas providing device for providing a carrier gas in the reaction chamber; wherein the apparatus is adapted to cause a mixture of the first and second precursors in the reaction space, thereby adjusting a mass ratio in the range of 1 part nitrate anions and/or nitrogen-oxygen compounds to 200 parts chlorides up to 10 parts nitrate anions and/or nitrogen-oxygen compounds to 1 part chlorides; and wherein the apparatus is further adapted to moderate the pH in a range of less than or equal to 3 to greater than or equal to −1 (−1≤pH≤3).

In the following, the disclosure is explained in more detail with reference to embodiments and with reference to the figures, whereby identical and similar elements are sometimes provided with the same reference signs and the features of the various embodiments can be combined with one another.

### BRIEF DESCRIPTION OF THE FIGURES

It shows:

FIG. 1 is a flow diagram of a first embodiment of the disclosure,

FIG. 2 is a plasma reactor,

FIG. 3 is a steam generator,

FIG. 4 is a nebulization system,

FIG. 5 is a sublimation device,

FIG. 6 is another embodiment of a sublimation device,

FIG. 7 is a carrier gas supply device,

FIG. 8 is an embodiment of a reaction chamber with gas vacuum pump,

FIG. 9 is an embodiment of a reaction chamber with static mixer,

FIG. 10 is a flow diagram of a possibly overcomplete embodiment of the disclosure,

FIG. 10a is a further flow diagram of an embodiment of the disclosure,

FIG. 11 is a flow diagram of a preferred embodiment of the disclosure,

FIG. 12 is a flow diagram of another preferred embodiment of the disclosure,

FIG. 13 is a flow diagram of yet another preferred embodiment of the disclosure,

FIG. 14 is a device for providing the aerosol or for carrying out the process for producing the aerosol,

FIG. 15 is a further device for providing the aerosol,

FIG. 16 is a further embodiment of a device for providing the aerosol as a rotary distributor,

FIG. 17 is an embodiment of a combination of a rotary distributor with a vertical wind turbine.

### DETAILED DESCRIPTION OF THE DISCLOSURE

As is shown by the present application, it is desirable for a climate-active aerosol 20 if the pH value is moderated to be quite acidic, namely in a range from −1 to 3, preferably from 0 to 2.5, and still more preferably from 0 to 2. There are various possibilities for adjusting the pH value, those which can be used in a technically and economically sensible manner being described in this disclosure.

One possibility is to provide a mixed metal salt aerosol or a mixed chloride aerosol containing metal ions and/or metal oxides, such as the “Aqua-Regia” aerosol outlined above, for the degradation of, for example, the greenhouse gases methane and ozone in the troposphere. Here, a photolytically activated oxidation effect of “Aqua-Regia” can be technically converted by chlorine (chlorine atoms and chlorides). For example, the chloride mixture aerosol presented, such as the activated “Aqua-Regia” aerosol, can be adjusted so that its particles and/or droplets are characterized by the fact that they contain an acidic mixture of sodium ions, nitrate ions, chloride ions, ferric ions and titanium dioxide formed by hydrolysis. In this example, the chloride mixed aerosol thus contains particles and/or droplets whose solid and/or liquid components consist of an oxide salt and salt solution mixture and which has a pH value of less than or equal to 3, preferably less than or equal to 2, and in which the “aqua regia” oxidation of chloride to chlorine atoms is particularly effective.

The technical equipment presented below is for the production of any “aqua regia” aerosol variants, including “aqua regia” aerosols activated by the aforementioned iron and/or titanium compounds. An activated “Aqua regia” aerosol is an “Aqua regia” aerosol containing iron salt and/or titanium dioxide to which an iron and/or titanium component has been added during production. The activating metal components, which are added to the “Aqua regia” aerosol in the manufacturing process, may in particular be salts of the transition metals iron and titanium and their hydrolysis products. Such a metal salt for the production of a metal salt mixture aerosol is a chloride mixture aerosol which comprises metal salt during production or in the educt aerosol (i.e., the chloride mixture aerosol to be emitted). Such a metal salt can be used, for example, as ferric chloride, ferrous chloride, ferric nitrate, ferrous nitrate, ferric sulfate or titanium tetrachloride.

The technical devices presented in this application can be modified or operated to provide a chloride mixture aerosol with and without metal salts in the generation of the aerosol and/or contained in the educt aerosol. The term “chloride mixture aerosol” used in the present description describes the mixture aerosol which contains the element chlorine, for example in a dissolved or gaseous state and preferably from the group of atomic chlorine, elemental chlorine, hydrogen chloride, nitrosyl chloride, nitryl chloride or chlorine nitrate. This is because the presence of chlorine (as elemental chlorine and chloride) is relevant to the aerosol emitted.

After their emission, the particles and/or droplets of the “Aqua Regia” aerosol variants exhibit a gaseous aura consisting of vaporous products of their photolysis and their reaction with oxygen and other oxidants as well as methane and other organic components of the troposphere, including, for example, ° Cl, Cl₂, HCl, ° NO₂, HNO₃, ClNO, ClNO₂. These components are part of the natural photochemical cycle in the “Aqua Regia” aerosol cloud. All components from which the “Aqua Regia” aerosol cloud is produced, and which contain these components as such or contain them in the form of their precursors or release them into the “Aqua Regia” aerosol cloud, can also be components of its production. The condensed particles of the “Aqua-Regia” aerosol variants may also have a condensed aura, which may contain nitrate, chloride, hydronium and metal ions as well as possibly activating components of ionic and/or oxidic iron and/or titanium components. An example of this is titanium tetrachloride vapor, which enriches the aerosol cloud with HCl vapor and titanium dioxide during its hydrolysis with atmospheric moisture.

Any metal elements or metal compounds present can be used as catalysts or to reduce the pH value, e.g., if the iron is added in reduced form, for example as iron pentacarbonyl vapor. Finally, the reactivity of the aerosol on the one hand and the costs, for example for the material or energy required to produce the aerosol, on the other, are a sensitive measure of whether the aerosol can be provided in large quantities.

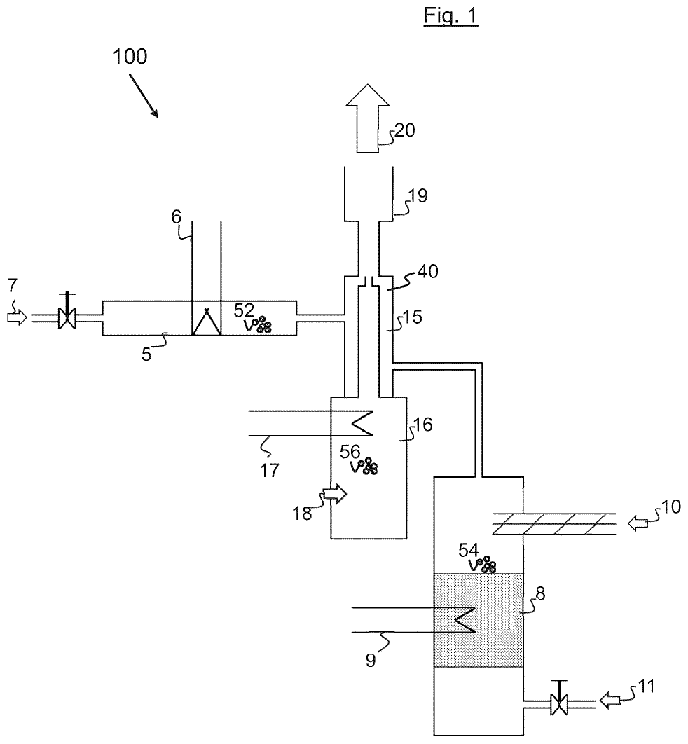

FIG. 1 now shows a first embodiment of a device 100 for providing a climate-active aerosol 20, and also for carrying out the process for providing the climate-active, self-activating, photoactive aerosol 20. A reactor 5 is used to provide the first precursor 52 with nitrate anions (e.g., nitric acid) and/or nitrogen-oxygen compounds in a reaction chamber 40. It has an air supply line 7 and a supply line 6, for example for electric current or for supplying energy. A sublimator 8 is used to provide the second precursor 54 with chlorides. In this example, it comprises a heating device 9 for supplying thermal energy to the sublimator 8. It also has a feed 10 for anhydrous solid ferric chloride and/or anhydrous ferric chloride-aluminum chloride mixture and a carrier gas inlet 11.

First and second precursors 52, 54 are provided in the reaction chamber 40 so that mixing takes place. The mixing can be further accelerated or promoted if a carrier gas 56 is supplied to the reaction chamber 40 for turbulent mixing and/or removal of the precursor mixture 52, 54. The carrier gas 56 may be generated by a carrier gas generator 16. The carrier gas 56 can be, for example, compressed air or exhaust gas, so that the carrier gas generator 16 can thus e.g., be a compressor, an (electric) motor-driven blower, a propeller-driven motor or an engine such as a marine diesel engine. An energy supply system 17 supplies the carrier gas generator 16 with energy, for example with electrical power in the case of the compressor or the electrically driven fan, with aviation fuel in the case of the propeller drive, with heavy fuel oil in the case of the marine diesel engine or with kerosene in the case of the jet turbine fan.

In the example shown in FIG. 1, the reaction chamber 40 comprises a gas jet vacuum pump 15. The aerosol 20 provided in this way is fed to the outlet 19, for example a chimney, and released into the atmosphere.

With a system 100 as shown in FIG. 1 as a flow chart, various process variants can be carried out, one of which is explained below by way of example. According to a variant 1, a ferric chloride-containing aerosol is first produced as reactant or second precursor 54, which is then converted into a ferric nitrate-ferric chloride mixed aerosol 20 by treatment with one or more educts from the group NO_{1,5+X}, including preferably nitric acid vapor, as first precursor 52. The basis of the production method according to variant 1 is the primary production of ferric chloride aerosol as second precursor 54, in FIG. 1 exemplarily in sublimator 8. The thermal nebulization process of ferric chloride uses the condensate droplet formation for the formation of ferric chloride aerosol 54, which occurs during the cooling of vaporous iron(III)chloride. This is a thermal nebulization process, which is illustrated in FIG. 1 with the reference signs 8, 9, 10 and 11. The sublimator 8 is, for example, a moving ferric chloride fixed bed, from which ferric chloride vapor 54 or its mixture with aluminum chloride vapor is converted by sublimation into ferric chloride vapor 54 by heating to 100 to 220° C. using a heating device 9 with inert gas 11 flowing through it.

The size of the condensate droplets and/or condensate particles formed that can be achieved with the sublimator 8 can be comparatively small, which is preferred in the context of this description.

An acidic ferric nitrate-ferric chloride mixed aerosol 20 according to variant 1 can thus be produced by vaporous and/or gaseous mixing of inorganic gaseous or vaporous nitrogen-oxygen reactants NO_{1,5+X} as the first precursor 52 to the ferric chloride aerosol 54 produced. The NO_{1,5+X} reactants include, for example, the substances nitric acid, dinitrogen pentoxide, nitrogen trioxide, nitrogen dioxide, dinitrogen trioxide, dinitrogen tetroxide, dinitrogen trioxide, nitryl chloride or chlorine nitrate. These are all substances which can form acidic mixed aerosol particles or droplet aerosols containing ferric chloride and ferric nitrate by hydrolysis, oxidation and/or condensation in the presence of moist ferric chloride aerosol and are therefore well suited for the preparation of the first precursor 52.

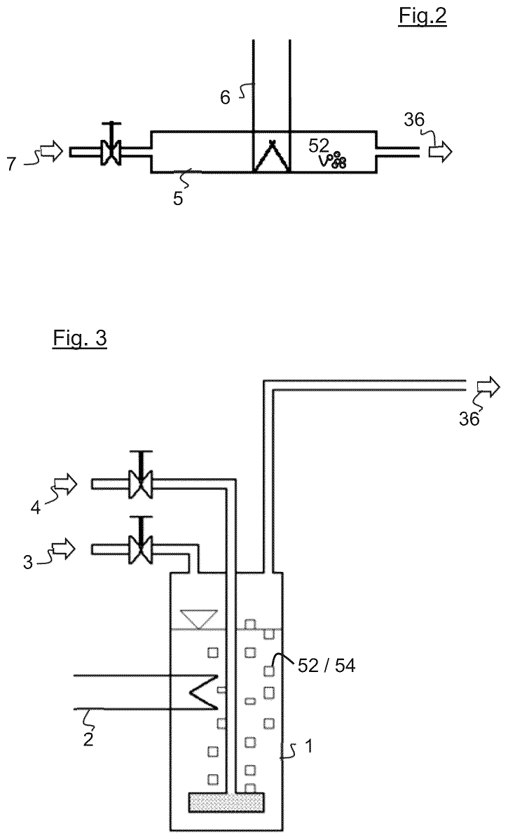

One way of producing the claimed nitrogen-oxygen compounds NO_{1,5+X} is to produce them in a plasma reactor 5, as shown schematically in FIG. 1 or 2, by means of discharge plasmas or plasmas formed by the action of electromagnetic waves. The gaseous and vaporous products are then mixed with the aerosol. This embodiment is shown schematically in FIGS. 1 and 2 under reference numbers 5, 6 and 7. The benefit of this manufacturing option is the utilization of the N₂ and/or O₂ content of the air for the reactant production of the first precursor 52.

FIGS. 2 to 10 show device components that can be used interchangeably or cumulatively, as they can be used in a device 100 for producing the aerosol 20. With reference to FIG. 2, the plasma reactor 5 already described is shown. With reference to FIG. 3, a steam generator 1 is shown schematically, which can be prepared for the generation of nitrogen-oxygen vapor as the first precursor 52, such as nitrate vapor (nitric acid vapor), such as with the supply of air, and for example also with more than 70 percent nitric acid, into the steam generator. The steam generator 1 can be set up for operation under changed temperature and/or pressure conditions. Alternatively or cumulatively, the steam generator 1 can be prepared for generating a chloride vapor as a second precursor 54 with the addition of air, and possibly supplemented by preferably more than 25 percent hydrochloric acid, into the steam generator 1. This process step can also be carried out under modified temperature and/or pressure conditions. In one example, the steam generator 1 can be used to vaporize nitric acid. Preferably, the steam generator is designed to evaporate aqueous hydrochloric acid solution; it can also be used to evaporate hydrolysis-sensitive liquid and/or volatile chlorides, for example one or more substances from silicon tetrachloride and titanium tetrachloride. The latter, however, is more complicated due to the necessary drying of the auxiliary gases passed through it. The evaporator 1 shown in FIG. 3 has a heating device 2, a feed 3 for supplying the starting material for producing a vapor from nitrogen-oxygen compounds (e.g., nitric acid vapor) or a chloride vapor and an air supply 4. The evaporator 1 is filled to a filling level and the quantity filled in is heated by means of the heating device 2. The educt 52 or 54 is fed to the reaction chamber 40 via the outlet 36. The preferred NO_{1,5+X} reactant (first precursor 52) for the reaction with ferric chloride aerosol or ferric chloride vapor (second precursor 54) is nitric acid, its aqueous solutions and its vapor. Nitric acid vapor can be produced by evaporation of nitric acid. This is preferably done by evaporating liquid nitric acid at temperatures below 100° C. The first precursor 52 can be produced by passing air 4 through a heated receiver 2 with liquid nitric acid 1 in a controlled manner.

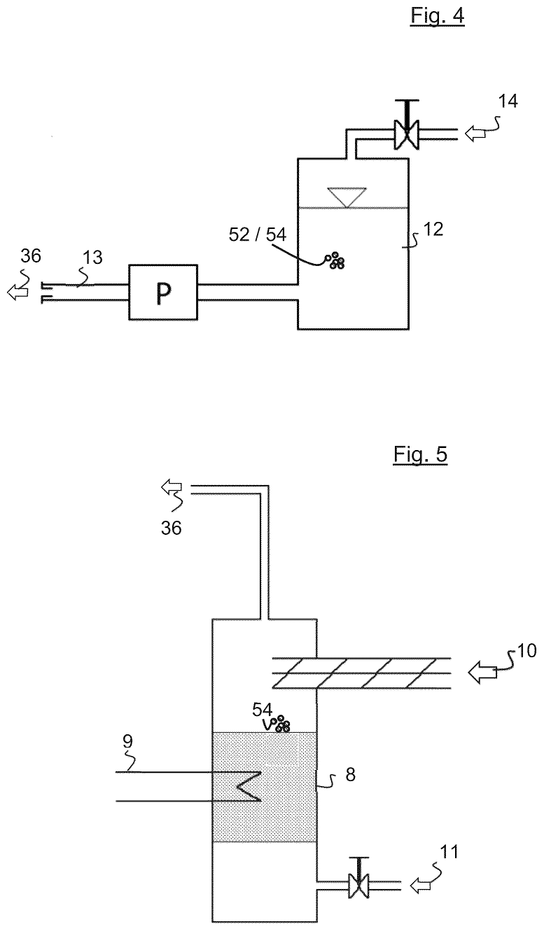

With reference to FIG. 4, a nebulization apparatus 13 is schematically described. The preparation of the second precursor 54, such as a ferric chloride aerosol, can be carried out by a simple non-thermal liquid nebulization device 13. With a non-thermal nebulization process, known mechanical and hydraulic liquid nebulization processes such as the nebulization of ferric chloride solutions by means of nozzles, with rotating brushes or by means of ultrasonic vibration can be carried out here. The nozzle principle is shown schematically in FIGS. 1 and 2 under the reference signs 12, 13 and 14 with the feed container 12 and the feed 14. A nebulization system 13, for example with a nozzle principle, can also be used to produce the ferric nitrate aerosol 52. Variant 2 for producing the acidic ferric nitrate-ferric chloride mixed aerosol 20, for example, is based on the production of ferric nitrate aerosol 52.

According to variant 3, ferric nitrate aerosol 52 can also be produced using the non-thermal liquid nebulization process with nebulization system 13. Since the acidic pH value of the aerosol cannot be adjusted here by gas- or vapor-forming acid or acid-forming substances, the solution to be nebulized must already be sufficiently acidic. In order to avoid uneconomical expenditure for corrosion protection and to obtain the smallest possible aerosol particles or droplets, a diluted ferric nitrate-ferric chloride mixture can be used in this variant. The excess water evaporates from the aerosol droplets after they are emitted into the atmosphere.

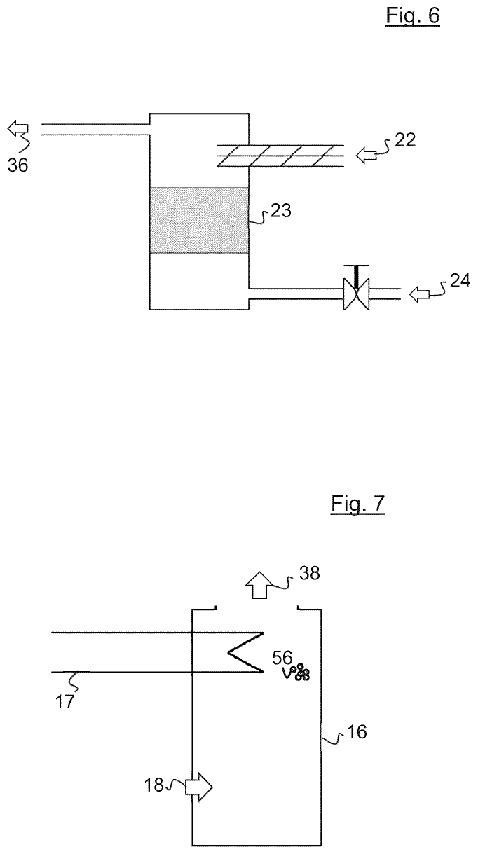

With reference to FIG. 5, the sublimator 8 is shown as an independent component, which has otherwise already been described with reference to FIG. 1. Identical reference signs denote identical components, as is the case throughout the description. With reference to FIG. 6, a pile bed 23 made of iron pellets is shown. The production of ferric chloride vapor 54 can also take place by the exothermic chlorination of iron pellets 23, as shown schematically in FIG. 5 under the reference signs 22, 23 and 24 with the metal pellet feed 22 and a chlorine gas feed 24.

With reference to FIG. 7, a carrier gas generator device 16 is visualized as a component of the device 100 with an energy supply 17 and a gas or air supply 18. The carrier gas 56 is prepared for aerosol lift. In other words, the carrier gas is such that it carries the aerosol, such as the particles and/or droplets of the aerosol, for at least an initial time and mixes with the aerosol or becomes part of the emitted aerosol and/or interacts with the droplets and/or particles of the aerosol, for example by moderating the pH value by means of the carrier gas 56. The carrier gas generator device 16 thus provides suitable carrier gas, for example for the operation of the gas jet vacuum pump 15. Examples of a carrier gas generating device 16 are a compressor, fan or even a vertically blowing propeller or jet engine, but an internal combustion engine such as a marine (diesel) engine can also provide a suitable carrier gas, or the air flow through an updraft power plant. For example, a reaction between NO_{1,5+X} compounds or nitric acid and ferric chloride is not affected by the exhaust gas as long as the exhaust gas contains more than 5% oxygen. If the exhaust gas to be used actually contains less than 5% residual oxygen, which is quite common in a modern engine, ambient air, for example, can be mixed into the still hot exhaust gas or the exhaust pipe after leaving the combustion chamber or cylinder, possibly even in variable quantities using flap techniques.

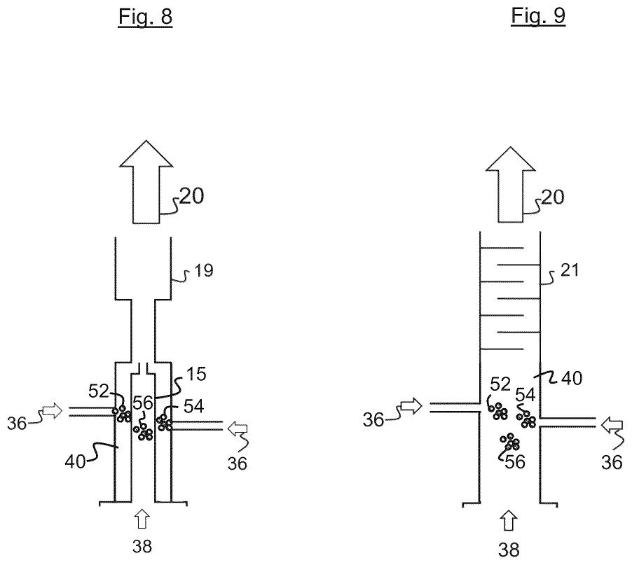

FIGS. 8 and 9 show two embodiments of a reaction chamber 40. The reaction chamber 40 is characterized by the fact that the first precursor 52 and the second precursor 54 are mixed together in a stream of carrier gas 56 for emission into an environment such as the atmosphere. The actual mixing process of the two precursors 52, 54 thus takes place in the reaction chamber 40 or begins there. For example, the mixing of hydrogen chloride vapor or the volatile hydrolysis-sensitive chlorides with the ferric nitrate aerosol according to variant 2 or the mixing of the nitric acid vapor or the other gaseous and vaporous NO_{1,5+X} compounds with the ferric chloride aerosol according to variant 1 can take place there, preferably supported by a gas jet vacuum pump 15, which is shown as an example in FIG. 8. The mixing of the gaseous and vaporous reactants 52, 54 with the ferric nitrate and ferric chloride aerosols can also be promoted by means of a static mixing device 21, an example of which is shown in FIG. 9.

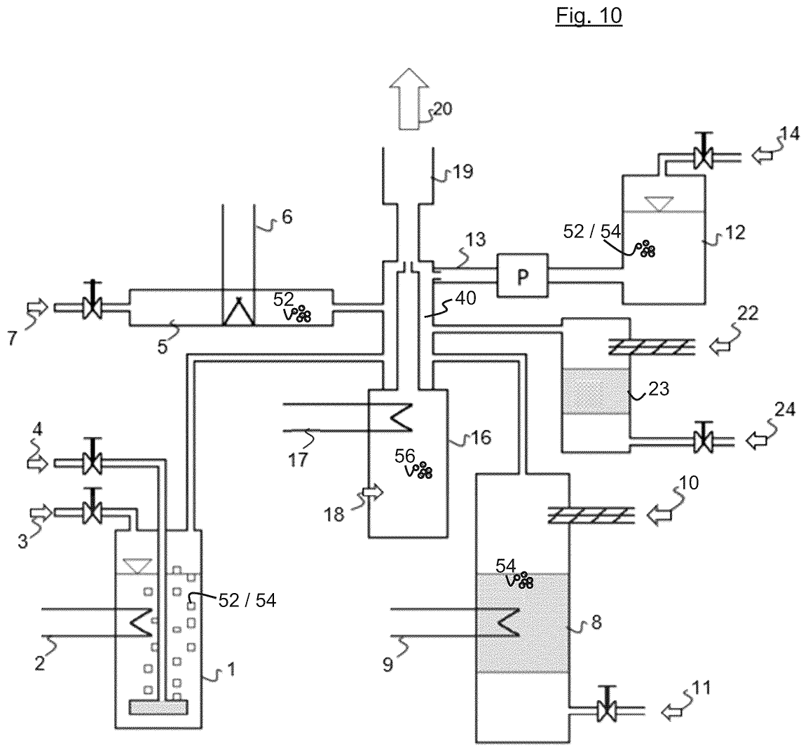

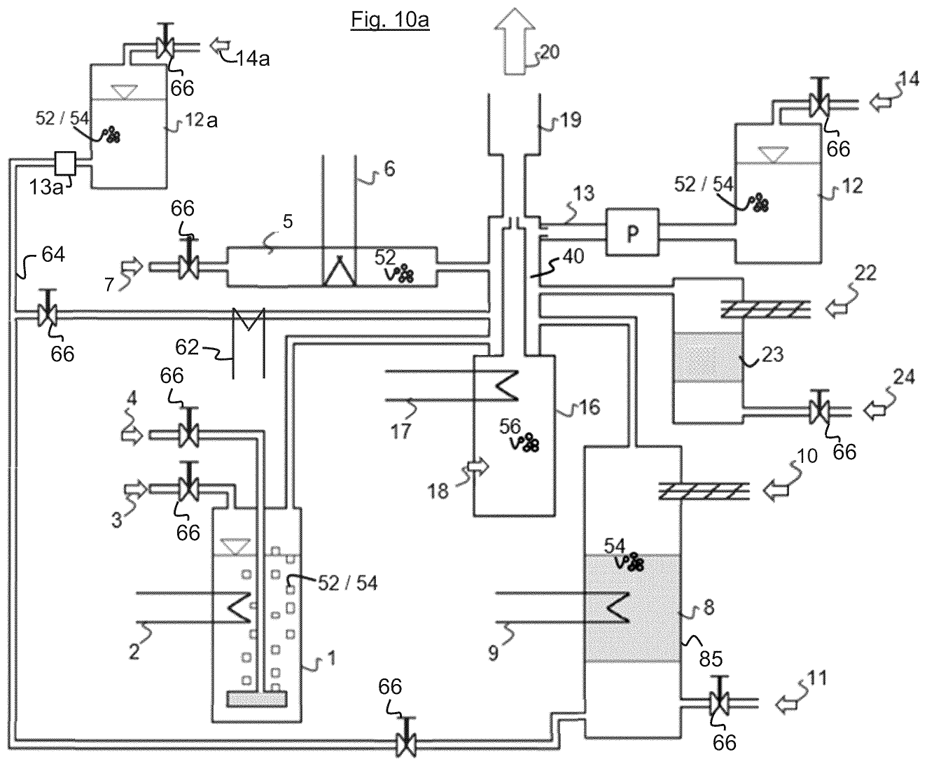

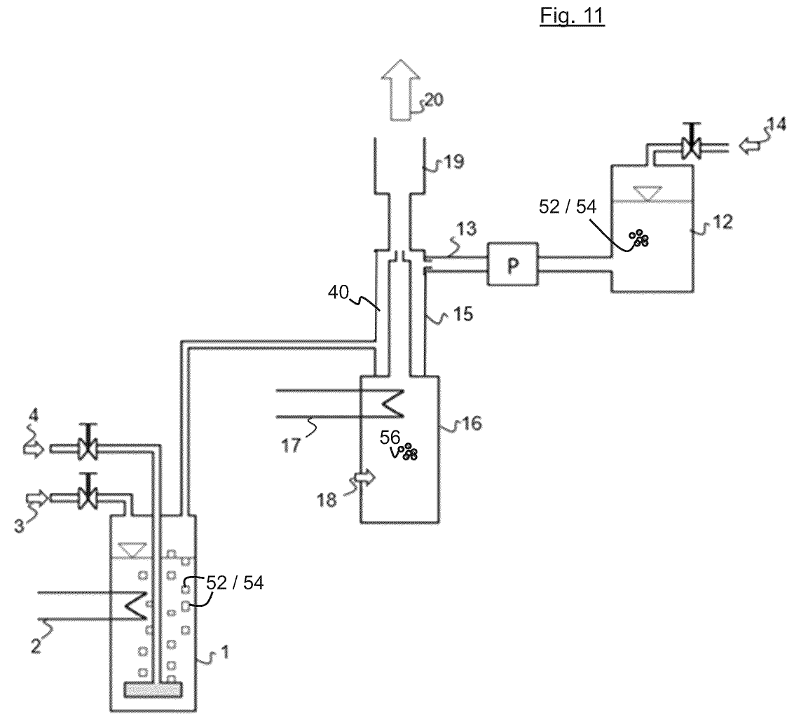

With FIG. 10, a flow diagram, which may be shown as overcomplete, depicts numerous of the aforementioned components of the device 100 together. It is therefore referred to as overcomplete because, although it is possible to operate all components of the device 100 simultaneously, this arrangement is not necessary for carrying out the disclosure. Rather, FIG. 10 illustrates several possibilities for producing the first precursor 52 and the second precursor 54 simultaneously.

Since all reference signs are used identically to the previous FIGS. 1 to 9, the previous description can also be adopted with regard to FIG. 10 (and the further figures). The first precursor 52 can be generated by means of the steam generator 1, for example by supplying air and HNO₃ to generate nitrate-generating steam. The first precursor 52 can alternatively or cumulatively also be generated by means of the reactor 5, such as a plasma reactor. Furthermore, the first precursor can also be provided by means of the nebulization system 13, for example by producing a ferric nitrate aerosol as the first precursor 52.

The second precursor 54 can be provided in the steam generator, for example by supplying nitric acid and air as described above. Alternatively or cumulatively, the second precursor 54 can be provided in the sublimator 8, by means of iron chlorination 23, or also by means of the nebulization system 13. Instead of or in addition to the gas jet vacuum pump 15 shown in FIG. 10, a static mixer 21 (see FIG. 9) can also be used.

With reference to FIG. 10a, a further flow diagram of an embodiment of the disclosure, which may be described as overcomplete, is shown. A second storage container 12a can be filled with a second feed 14a and serves, for example, as a feed to a nebulization system 13a. Various low-boiling starting materials, for example TiCl₄, SiCl₄, Fe(CO)₅ individually or as chlorides in a mixture, can be used here in order to provide either the first precursor 52 or the second precursor 54 in the further course, or as carrier gas 11 for modifying or providing in other processes such as in the sublimator 8. Thus, the mist 52, 54 provided by the nebulization system 13a can be fed directly to the reaction chamber 40. For example, using a heating device 62 in the feed line 64 for vaporization, the aforementioned low-boiling starting materials can be introduced into the reaction chamber individually or as a mixture as vapor.

For example, the starting material 11, in particular TiCl₄ vapor or SiCl₄ vapor or SiCl₄—TiCl₄ mixed vapor, can be provided as a liquid at the sublimator 8 from the nebulization system 13a. Due to their comparatively low boiling points (53° C. SiCl₄; 136° C. TiCl₄), the chlorides of titanium and silicon can also be fed into the sublimator 8 as a liquid mixture or carrier gas mixture instead of the inert gas 11. The chlorides evaporate in the sublimator 8, already below the ferric chloride bed 85, where they can act in the sublimator 8 instead of the carrier gas 11.

A liquid mixture of titanium tetrachloride, silicon tetrachloride, ferric chloride and aluminum trichloride is produced as a relatively inexpensive intermediate product during the carbochlorination of ilmenite and rutile ores in the Kroll process for the production of titanium. Inexpensive because the complex purification processes required to produce pure titanium, such as distillation and reaction with magnesium or sodium metal, are not yet used at this early stage of production.

Further optional iron-containing compounds can be formed with iron pentacarbonyl (Fe(CO)₅). This is an easily vaporizable compound (Kₚ 105° C.), which has the desirable property of decomposing into nano-particulate iron oxides in the vapor phase or in the atmospheric aerosol cloud. These oxidic iron particles would then be effective as condensation nuclei and activators for chlorides, nitrates and titanium oxides and thus suitable ingredients for the process presented herein for the production of the aerosols 20 mentioned above and below. However, the production conditions for Fe(CO)₅ are not trivial at the present time.

In addition to the “partial representation” of FIG. 10 already shown in FIG. 1—i.e., using only individual components for the device 11—operation as shown in FIG. 11 is also possible. Here, a steam generator 1 and a nebulization system 13 are used. This variant can also have a static mixer 21 instead of or in addition to the gas jet vacuum pump 15 shown (see FIG. 9).

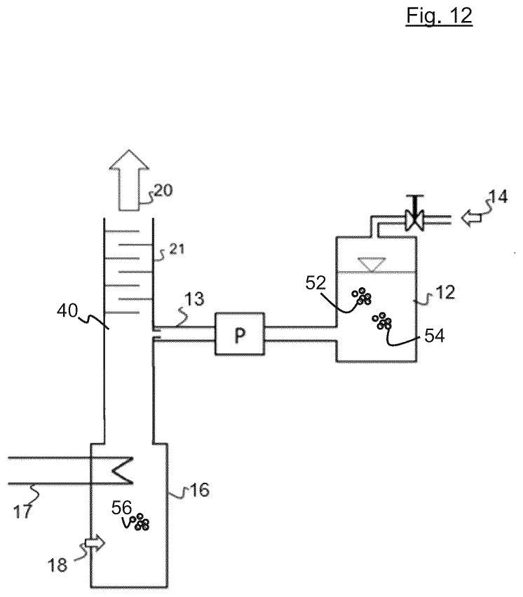

FIG. 12 shows a variant of the device 100 in which both the first precursor 52 and the second precursor 54 can be provided in the nebulization system 13. There, for example, both liquid ferric nitrate solution and liquid ferric chloride solution are supplied in feed 14 and nebulized together.

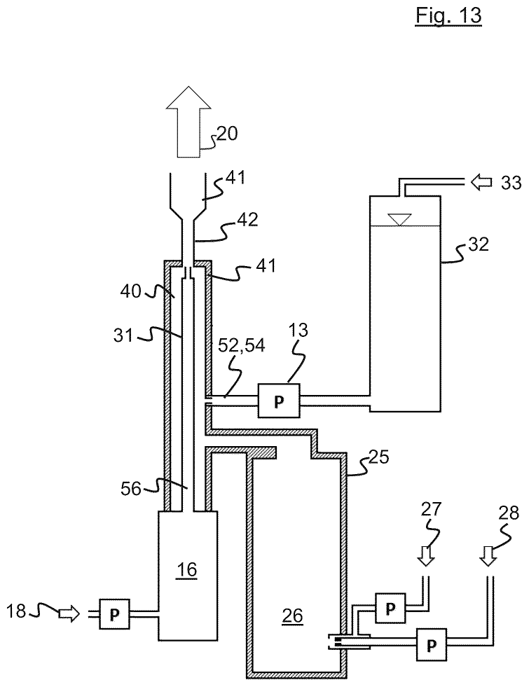

FIG. 13 shows a relatively compact embodiment of the disclosure for producing a climatically active aerosol 20 with a nebulization system 13 for providing a mixing precursor 52, 54, which is already premixed before being introduced into the reaction chamber 40. The premixing of the mixed precursor 52, 54 can be realized in that a mixture of a first nitrate-containing liquid starting material, preferably as an aqueous solution, and a second chloride-containing liquid starting material, preferably also as an aqueous solution, is provided at the inlet, which is introduced together into the feed tank 32. The mixture 52, 54 is then fed jointly to a pump and atomized by means of the evaporator 13 directly into the reaction chamber 40 via one or more nozzles. In this case, too, a first precursor 52 and a second precursor 54 are introduced into the reaction chamber 40 as a result.

In a further part of the system, additional sulfur combustion 26 can take place in a sulfur combustion furnace 25 to provide a sulfur gas which, together with the gas provided from the carrier gas generator 16, such as air, forms a reactive carrier gas 56. Liquid sulfur 27 and combustion air 28 can be fed into the sulfur combustion furnace 25. For example, the function of the sulfur combustion furnace 25 and the carrier gas generator 16 can be completely realized by a marine diesel drive.

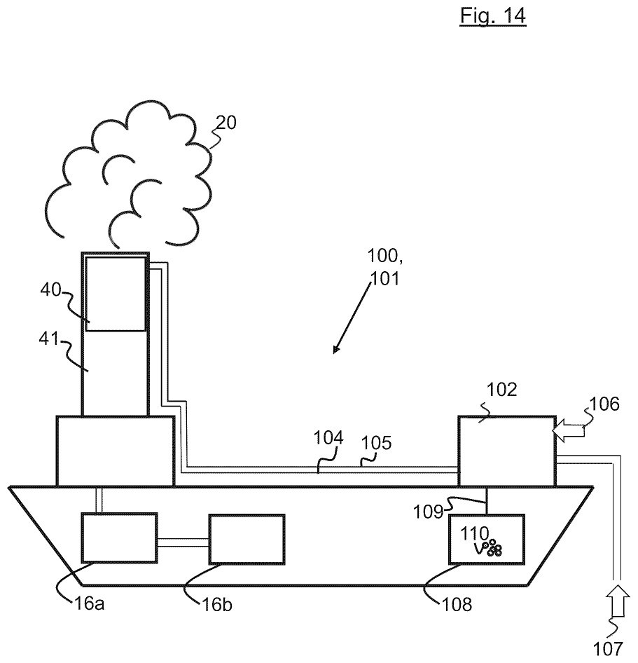

With reference to FIG. 14, a ship is shown as an aerosol emitter to represent various installation situations. A ship's engine 16a is used as a carrier gas generator, which is operated by fuel 16b such as heavy fuel oil containing sulfur. Exhaust gas 57 is fed as carrier gas to a reaction chamber 40 set up in the chimney 41. Parts of the components of the system 100 can be arranged in the equipment compartment 102 of the device 100, as shown e.g., in FIGS. 1 to 13. Depending on the embodiment, an air supply 106 may be provided for receiving oxygen and/or nitrogen, such as for preparing the first precursor. A water supply 107 may be provided for receiving chlorine or chloride, for example from sea salt, for preparing the second precursor 54. A storage or precursor chamber 108 may be provided and connected to the equipment chamber 102 via a supply line 109, for example for supplying metal material 110 into the equipment chamber 102, for example granulated iron or titanium or aluminum, for generating the first and/or second precursor 52, 54. The first precursor 52 may be supplied to the reaction chamber 40 by means of the supply line 104 and the second precursor 54 by means of the supply line 105.

The device 100 shown in FIG. 14 is also an exhaust gas treatment system 101, since exhaust gas treatment takes place e.g., in the reaction chamber 40, in that pollutants such as sulfur and/or NOₓ can be removed from the exhaust gas for the formation of the aerosol 20 presented here or the sulfur and/or NOₓ participates as a pH moderator and/or as a precursor in the generation of the climate-active aerosol 20. Depending on the configuration of the device, the transformation of the precursors 52, 54 into the claimed aerosol 20 can continue in the emitted aerosol cloud 20 after leaving the reaction chamber.

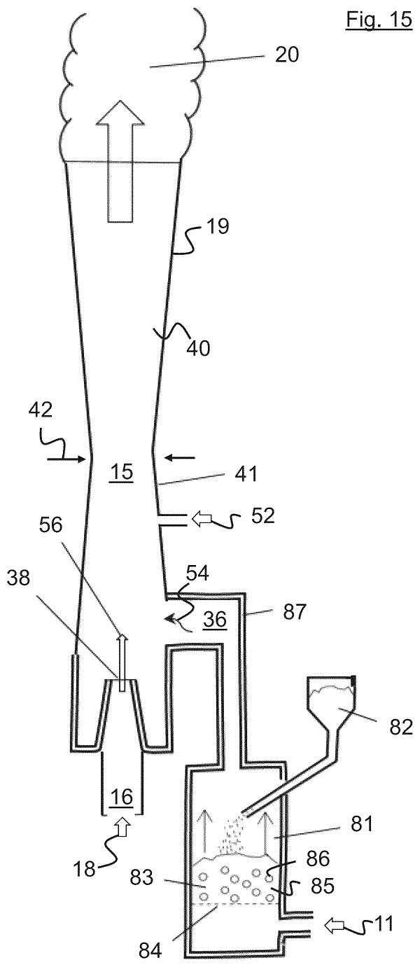

FIG. 15 describes a device and a method for reducing the sublimation temperature of iron(III)chloride to a maximum of 150° C. and for improving the mixing of the iron(III)chloride vapor stream with the gas jet in order to increase the proportion of aerosol particles with diameters<0.1. The device components may be interchangeable with previously described components of the device 100, as the skilled person will recognize.

Solid, anhydrous ferric chloride crystalline material 83 or aluminum chloride mixture crystalline material 83 is conveyed from the closed storage container 82 into the sublimation chamber 81 of the sublimator 8 and deposited on a carrier plate 84—preferably a flat or cylindrically shaped gas-permeable carrier plate 84. In the sublimation chamber 81, a mixture of ferric chloride vapor 54 and carrier gas 11, here preferably inert carrier gas 11, is generated from the mechanically moved bed of solid, anhydrous ferric chloride crystal material 83 and introduced into the gas jet vacuum pump 15. In addition, the gaseous NOₓ 52 produced in the plasma reactor 5 is introduced into the gas jet vacuum pump 15. This mixture is then further mixed in a reaction chamber 40 with the gas generated by a gas jet from carrier gas 56, resulting in a NOₓ-iron(III)chloride aerosol plume 20. Chemical reaction with the atmospheric oxidizing agents produces the “activated aqua regia” aerosol plume, which is particularly effective for methane degradation.

Improved mixing of ferric chloride vapor 54 with NOₓ vapor 52, and air or flue gas 56 produces an aerosol plume 20 containing smaller particles. The mixing of the precursors 52, 54 with the carrier gas 56 can be improved by reducing the diameter of the iron(III)chloride emission tube or stack or exhaust 41 to a constriction 42 just downstream of the point where the iron(III)chloride vapor 54, the NOₓ vapor 52 and the gas jet 56 initially encounter each other. The emission tube 41 gradually narrows towards the constriction 42 to about one third of the diameter of the emission outlet tube, or at most 3 to 20 times the diameter of the outlet 38 of the carrier gas generator 16, after the gas jet has left the gas jet generator 16 into the emission tube 41. The movement of the gas jet through the aerosol emission tube 41 thus acts as a jet vacuum pump 15. The increased mixing turbulence achieved by this arrangement also leads to an increase in the proportion of iron(III)chloride aerosol particles<1 m in the aerosol plume 20 generated.

The jet gas movement through the emission tube 41 also reduces the pressure in the sublimation chamber 81 via the entry of the iron(III)chloride vapor 38 into the emission tube 41. The reduced pressure increases the sublimation rate in the iron(III)chloride bed 8. This makes it possible to reduce the sublimation temperature in the sublimation bed 8 by up to 50° C., and depending on the design and specific geometric layout, possibly even further.

Instead of the movement of the iron (III)chloride bed 85 induced by the velocity of the carrier gas in the sublimation chamber 81 promoting sublimation, the sublimation rate of the anhydrous iron (III)chloride pieces 83 may instead be enhanced by mechanically inducing movement of the iron (III)chloride bed 8 by stirring, shaking or vibration, or combinations thereof. It can also be further improved by grinding using hard grinding particles such as glass or ceramic beads in the sublimation bed 85—which can therefore also be referred to as a “moving sublimation bed”.

A lower sublimation temperature and a lower sublimation pressure reduce the amount of by-products and the required carrier gas throughput. The lower sublimation temperature made possible by the gas jet vacuum pump 15 also reduces undesirable side reactions, in which the thermal decomposition of ferric chloride to ferrous chloride and chlorine or the formation of oxic iron compounds from any water or oxygen content can lead to undesirable precipitation in the sublimation bed 8 during the sublimation process. A lower temperature and the use of the jet vacuum pump 15 as a “container” for mixing the iron(III)chloride vapor with the gas jet 56 also allow a smaller amount of carrier gas to be used to remove the iron(III)chloride vapor from the sublimation bed 8.

The following four features can be used in combination to enable both a reduced sublimation temperature, a reduced carrier gas flow rate and an increased proportion of submicron aerosol particles/droplet size:
I) Reduced pressure in the sublimation chamber 81. Pressure levels below 200 mbar can be achieved and are preferred.
II) During the sublimation process in the sublimation chamber 81, the iron(III)chloride bed 85 is agitated, for example by shaking, vibrating, grinding or stirring, or a combination thereof.
III) comminution of the anhydrous iron(III)chloride particles within the bed 85 during the sublimation process in the chamber 81. The aforementioned agitation methods such as shaking, vibrating or stirring the sublimating iron(III)chloride bed 85 are sufficient to effect this comminution.
IV) Formation of iron(III)chloride as an aerosol plume (1) by mixing iron(III)chloride vapor 54 with an air jet 56 and/or the flue gas jet of a turbine jet engine 16 in the emission tube 41, which acts as a gas jet vacuum pump 15.

These four innovations may be further improved to produce iron(III)chloride plumes as follows. A preferably preheated carrier gas 11 or inert carrier gas 11 is fed into the sublimation chamber 81 below the gas-permeable carrier plate 84, which carries the moving sublimation bed 85. The plate is located inside the sublimation chamber 81, which is heated separately by means of a heating device 9. The carrier gases 11 selected are those that are inert at the selected sublimation temperature. The preferred carrier gases 11 for this purpose are inert gases that do not react chemically with gaseous ferric chloride at temperatures between 15° and 220° C. These are, for example, CO₂, N₂ and, at the lowest sublimation temperatures, also dry air. When flowing through the sublimating iron(III)chloride bed 85, the carrier gas mixes naturally with the sublimated iron(III)chloride vapor and transports it to the inflow point of the jet vacuum pump 15.

The formation of submicron condensation nuclei and the increased mixing turbulence of the jet pump 15 can generate submicron iron(III)chloride aerosol particles. The mixture of hot carrier gas 11 and iron(III)chloride vapor 54 is drawn out of the iron(III)chloride bed 85 in the sublimation chamber 81 by the negative pressure induced by the gas jet 56 within the emission stack 41 and drawn into the emission stack 41 at 36. During the intense turbulent mixing of the iron(III)chloride vapor with the humid gas jet within the emission stack 41, abundant droplets and/or solid particles (hereinafter simply referred to as “particles”) of hydrolyzed iron(III)chloride with particle diameters of mainly <0.1 μm are formed by a hydrolysis reaction. These particles then serve as condensation nuclei for further chemical and/or physical condensation of the remaining iron(III)chloride vapor.

While the precipitation of iron(III)oxide or iron(III)hydroxide or even iron(II)chloride in side reactions and/or the condensation of solid iron(III)chloride is problematic for surface scaling and coating, these phenomena are desirable during and after the mixing of iron(III)chloride vapor with the blasting gas. This is because these substances all react quickly chemically with the water vapor in the blasting gas and produce the nanoparticles mentioned above. These nanoparticles serve as condensation nuclei for the physical condensation of the remaining iron(III)chloride vapor. Rapid and turbulent mixing of the ferric chloride vapor with the jet gas in the stack 41 is crucial to ensure that the final condensation process produces the largest possible proportion of minute nanoparticulate aerosol particles in the exhaust plume 20.

The effect of the gradual reduction in diameter of the emission stack 41 towards the constriction 42, thereby establishing the operation of a vacuum pump 15, provides a gas jet-vacuum mixing principle. When using a gas jet with less than 50% moisture, it ensures that most of the generated iron(III)chloride aerosol particles in the emitted iron(III)chloride aerosol plume 20 can have diameters of <0.1 μm. The comminution of the source material enables a higher proportion of the solid ferric chloride sublimated to vapor.

In the context of the present disclosure, it was found that even at sublimation temperatures of <200° C., a certain coating of the surface of the feedstock with iron(III)chloride and/or iron(III)oxides can occur. This undesirable effect also reduces the amount of anhydrous ferric chloride feedstock that sublimes to pure ferric chloride vapor 54. This problem can be ameliorated by measure III) described above, namely the addition of grinding media 86 to the agitated ferric chloride bed 85. Preferred grinding media 86 are glass beads. Ceramic beads can also be used. Preferred bead diameters are between 1 and 10 mm. In FIG. 14, grinding media 86 are shown as circles in the sublimation bed 85.

According to previous ideas, a gas jet is used only to generate the iron (III)chloride aerosol plume 20. As realized in the context of the present disclosure, a pressure drop caused by the movement of the gas jet through the tapering diameter of the chimney 41 towards the constriction 42, and thus by introducing a gas jet vacuum pump 15, can improve the yield. In addition, the improved mixing caused by the constriction 42 or the vacuum pump 15 leads to smaller aerosol particles. The pressure drop in the sublimation chamber 81 enables the generation of iron(III)chloride vapor with fewer of the solid by-products mentioned above, and the improved mixing of iron(III)chloride vapor with the jet gas 56 in the emission stack 41 results in an iron(III)chloride plume 20 with an increased proportion of aerosol particles containing iron(III)chloride of <0.1 μm.

Potentially suitable gas jet generation systems 16 can be those used for ventilation, air compression and for propeller and jet engines. Steam boilers can also be used to generate compressed hot water vapor. Preferred gas jet generators 16 for production capacities up to a content of 0.5 to 1 t ferric chloride per hour in the generated aerosol plume 20 are fans and air compressors. To generate larger quantities of propellant gas for driving larger emission plumes 20 with >1 ton of ferric chloride per hour, the gas jet 56 is generated, for example, by a turbine jet engine, which is preferably arranged vertically (as shown schematically in FIG. 14), whereby the exhaust gas jet 56 blows into the emission stack 41 and thus also contributes to the generation of a pressure drop according to the principle of the jet vacuum pump 15. Large capacities for the production of iron(III)chloride aerosols 20 can be achieved by using more than one jet vacuum pump 15.

To prevent unwanted coating by precipitation (condensation) of ferric chloride solids on cold surfaces within the system, these surfaces 87 may be heated and/or covered with thermally insulating material to allow them to be heated by the gases 54 flowing through the system. Surfaces that are hotter than the temperature of the sublimation chamber are cooled and/or thermally insulated to prevent them from being covered by chemical conversion products of the ferric chloride vapor, such as solid ferrous chloride and/or ferric oxides. The latter is possible, for example, if the gas jet is generated by a turbine jet engine. Both types of surfaces are shown in FIG. 1 by the two parallel lines representing the surfaces 87.

In other words, it is desirable to carry out the sublimation process under the jet pump vacuum of a gas jet vacuum pump 15, and thus to place the sublimation temperatures in the range from 100 to 230° C., preferably 150 to 210° C. This also has the economic benefit that the consumption of inert gas 11 as an auxiliary sublimation agent can be reduced by using the jet pump vacuum. For the production of the suitable iron-“activated aqua regia” aerosol clouds 20 in the atmosphere in a plant 100, up to more than one ton per hour of ferric chloride aerosol vapor can be produced and emitted, as an example. Various embodiments of gas jet vacuum pumps 15 suitable for this purpose have already been described in this description.

After leaving the emission stack 41, the “activated Aqua Regia” aerosol plume remains in the troposphere, e.g., over the ocean, for days to weeks, depending on the prevailing wind and precipitation patterns in the selected region. When the sun shines, the particles of the ferric chloride aerosol plume carry out 20 photochemical reactions that can reduce the greenhouse gases methane and ozone in the troposphere. The particles also provide direct cooling by increasing the albedo through both the formation of new clouds and the brightening of existing clouds, see Oeste et al, (2017).

After the ferric chloride aerosol particles either rain down from the atmosphere or otherwise settle on the sea surface, they are hydrolyzed to colloidal iron hydroxide. Since iron is a necessary but highly depleted micronutrient in the abyssal ocean, this iron-containing colloid is almost completely and rapidly bound and consumed by photic zone (PZ) phytoplankton, which are very well adapted to survive in these iron-poor seas.

Therefore, phytoplankton production in the PZ increases immediately after feeding by ISA pumps. This creates conditions at the sea surface for an increased CO₂ absorption rate from the atmosphere per unit area of the ocean.

Overall, the aerosol in its various forms not only achieves methane degradation, because this mixed aerosol is of the greatest benefit to the environment where the phytoplankton in the photic zone of the sea surface in the abyssal zone suffers from iron and nitrogen deficiency. Immediately after the claimed aerosol enters the ocean through precipitation, the phytoplankton blooms, removes CO₂ from the atmosphere and, through its increased DMS production (“smell of the sea”; DMS=dimethyl sulfide), ensures cloud formation through condensation nucleation from sulfate and sulfonic acid aerosol as an oxidation product of DMS. Thus, the claimed substance not only causes a climate-impacting greenhouse gas degradation (CH₄, VOC, soot and smoke particles, CO₂ and tropospheric O₃) but also a cooling of the troposphere through cloud formation and light coloration of the sea surface due to phytoplankton proliferation by albedo increase of ocean surface and lower troposphere above the ocean.

A preferred field of application of the process according to the disclosure, in addition to the targeted methane degradation in the atmosphere, is also increasing the reflectance of the earth's surface, such as the glacial ice surfaces of Greenland and Patagonia, and possibly also Antarctica, for example wherever the temperatures on the ice surfaces rise above freezing point in the summer months, in order to stop or at least reduce the dew process by means of the aerosol. These ice surfaces tend to darken due to algae and moss formation, especially during the thawing phase. The permanent sea ice areas in the Arctic are also suitable for the albedo increase caused by the aerosol used. This can be remedied with the process variant according to the disclosure by the additional use of wind turbines, which can be used both as energy suppliers for evaporation or sublimation or also to provide energy for the operation of plasma reactors and/or electrolysers for air conversion into precursors. The respective wind turbine used for this purpose also supplies the energy for the nebulization of liquid or vaporous chlorides to aerosols, for example to trigger the increase in albedo by white coloring of the glacier ice or the formation of white ground fog and possibly white clouds with the claimed particularly white-colored “Aqua Regia” aerosols containing titanium-containing hydrolysates and at the same time trigger the degradation of methane.

The lack of precipitation on extensive ice surfaces in the bright half of the year and the prevailing katabatic wind, which blows from the center of the ice surface to its edges, are particularly helpful. This can pick up the stressed aerosols and, as in Greenland for example, carry them as far as the coast and, if necessary, deposit them. Where the katabatic wind meets the warmer ocean, it warms up, picks up evaporating water and rises, forming clouds. These clouds are characterized by their particularly intense white coloring due to their content of titanium hydrolysate condensation nuclei.

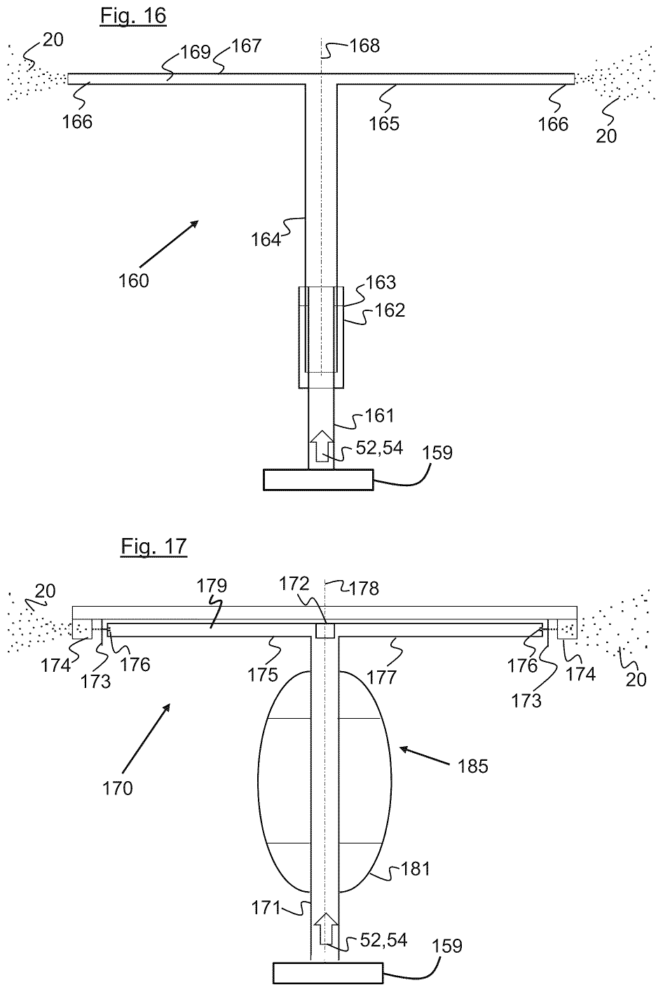

In order to effectively color ice surfaces white, it makes sense to provide the aerosol with a higher content of rapidly sinking aerosol particles. With reference to FIGS. 16 and 17, this can be achieved, for example, by nebulizing liquid precursors 52, 54, such as titanium tetrachloride or seawater or aqueous solutions containing nitrate and chloride. In order to avoid a complicated filter process for separating the finest particles, it is desirable to use nozzles 166, 176 with a relatively coarse internal nozzle diameter for this effect, for example with an internal nozzle diameter of 0.1 mm, for example ±30 μm. For this purpose, nebulization can take place according to the droplet impact principle on baffle plates 175, after droplet sizes of less than 5 μm in diameter can be achieved with sufficient droplet impact velocity on solid surfaces as baffle elements. In order to divide the liquid jet emerging from the atomizing nozzles into a droplet jet, two options are preferably used.
a) The chamber 179, from which the liquid to be atomized enters the nozzles, is sonicated by means of a membrane vibrating at ultrasonic frequency. The resulting pressure fluctuations in the liquid-filled chamber break up the emerging jet of liquid to be atomized into small droplets.
b) The liquid jets to be atomized emerging from the nozzles 166, 176 are divided into droplets by a perforated plate 174 passing at a sufficiently high speed between nozzles 166, 176 and impact surface 175. Such an aerosol generator with impact surfaces 175 and perforated plate 174 is shown schematically and as an example in FIG. 17.

With reference to FIG. 16, an embodiment of a rotary distributor 160 is shown, which has a static feed part 161, a rotating part 164 connected thereto via a coupling element 162 and a star distributor 165 mounted on the rotating part 164. The part 164 rotating about the axis of rotation 168 is sealed off from the coupling element 162 and/or the static part 161 in the region of the coupling element 162 by means of a sealing element 163. The sealing element 163 can be designed as a liquid paraffin seal, for example. The star distributor 165 preferably has 3 to 7 star arms 167, each with an outlet 166, and can, for example, be driven by an electric motor or a wind turbine. For example, the rotary distributor 160 can also be designed as an integral part of a modified wind turbine, such as one having a vertical axis of rotation (VAWT, vertical axis wind turbine), such as a Darrieus rotor, a Savonius rotor or Flettner rotor, whereby the star distributor 165 is correspondingly aerodynamically shaped and forms rotor blades or rotates as a supplementary part of the wind turbine. This can be designed in such a way that for aerosol production with such a rotary distributor 160 designed as a wind turbine, electricity or energy no longer has to be supplied from outside, but instead, when wind sets in, a wind-driven rotation starts, which generates electricity and the aerosol 20 can be produced, provided and distributed as a result. The fact that in this example this only takes place when there is wind may not be an undesirable result at all, but rather a benefit, as the aerosol 20 is then distributed by the wind. The fluid in the star arms 167 is expelled from the outlets 166 by the rotation of the rotating rotary distributor 160. Subsequently, a pressure reduction occurs in the upper part of the rotary distributor 160 in the manner of a centrifugal pump, whereby further fluid can be fed from the supply pipe 161, 164 into the star distributor 165, whereby the distribution of the aerosol 20 by means of the rotary distributor 160 is maintained during operation, depending on the design, even without the supply of energy (electricity) to be provided.

With reference to FIG. 17, in contrast to the embodiment of FIG. 16, the vertical part 177 is designed to be continuous and, for example, rotatably mounted in a base (not shown). The fluid to be ejected is sent to an atomizer 174 after the outlet 176 and then atomized very finely by means of a baffle element 175, as will be described in further detail below. FIG. 17 also shows a modified wind turbine 185, in this case designed as a Darrieus rotor with rotor blades 181, which is combined with the rotary distributor 170. The rotary distributor 170 rotates, driven by the modified wind turbine 185, with the rotation of the latter. The simple design of a vertical wind turbine 185 makes it possible to better protect the components used from the aerosol 20, which may still be highly corrosive at the beginning during the mixing time, or its ejected precursors 52, 54, or to make them insensitive to corrosion.

In the example of FIGS. 16 and 17, the space between the outlets 166, 176 formed as circular discs is used as the fluid chamber 169, 179, wherein the opening 166, 176 at the circular periphery between the two discs is closed by a cylindrical pipe segment; excluding the, preferably two or more, nozzle openings 166, 176. The cylindrical chamber 169, 179 designed in this way is supplied with the fluid to be atomized, preferably in the form of a liquid, via an axially attached pipe. The necessary pressure in the periphery of the chamber to force the fluid to be nebulized through the nozzles 166, 176 is achieved by centrifugal force by setting the chamber 169, 179 in rotation, for example by means of an electric motor drive. By means of the centrifugal force effect, the fluid ejected from the nozzles 166, 176 is also sucked in and replaced by the attached, also rotating tube from the storage container 159 or the vertical supply line parts 161, 164, 171 in the case shown.

In order to achieve the necessary relative speed between the fluid ejected from the nozzles and the impact surface 174 shown in FIG. 17, the rotation principle is also used in that the impact surfaces 174 are operated by a motor-driven rotor with an identical rotor axis position as the rotating nozzle chamber, but in the opposite direction of rotation. The impact surfaces are arranged in such a way that the highest possible proportion or even the entire proportion of the liquid jets divided into droplet jets arrive on the surfaces of the impact elements 174 and are atomized there into very fine droplets. Accordingly, the perforated plate 173 for dividing the liquid jet into droplets is also fixed to the rotor between the impact surfaces 174 and the nozzle jet outlet 176.

In most applications for the use of “Aqua Regia” aerosol, the focus is on producing the finest possible aerosol 20 in order to optimize the heterogeneous reactions for chlorine atom formation and the mass transfer between gas phases and condensed phases. Particles that are as finely divided as possible are desirable for this because they offer the largest mass transfer surface. These particles are preferably produced by chemical and physical condensation processes. Such as through hydrolysis and oxidation processes. It is therefore preferable to use gases and vapors as precursors 52, 54 of the “Aqua Regia” aerosols 20, preferably HCl, SiCl₄, TiCl₄, FeCl₃, AlCl₃, HNO₃, NO₂, N₂O₅.

Aerosol generators 160 as shown in FIG. 16 are the preferred choice for this purpose. They are characterized by their simple and robust design. They can also be used to produce rapidly sedimenting “Aqua Regia” aerosols 20. The centrifugal principle and the Venturi effect by creating a negative pressure are also used as conveying and emission devices for the gaseous and vaporous precursors 52, 54. Both principles are fulfilled by two or preferably several star-shaped tubes 167, which communicate hydraulically with a central tube 161, 164 arranged axially on the star-shaped tube, through which the centrifuged or extracted gases and/or vapors are replaced. By simultaneously feeding and emitting both precursor types 52, 54 gaseous and/or vaporous components containing NOₓ and chloride from the respective storage containers 159 or production facilities in the central pipe 161, 164 to the rotating tube star 165, the formation of the “Aqua Regia” aerosol 20 is completely shifted to the emitted precursor cloud.

The size of the aerosol particles formed in the “Aqua Regia” aerosol cloud 20 from the emitted gas and/or vapor is also dependent on the original concentration of the precursor gases and vapors: larger aerosol particles are formed from high concentrations due to increased coagulation of the primarily formed particles, low concentrations form smaller aerosol particles due to low coagulation processes. In this case, the precursor gas concentration can be easily influenced by the circumferential speed or the number of revolutions per unit time of the rotating tube star 165: The higher the circumferential speed, the higher the ejected gas mass and thus also the aerosol particle size. Accordingly, the aerosol particle size can also be influenced here.

In still another embodiment, instead of the rotating tubular star 165, 175, a rotating flat chamber between two circular disks can fulfill the same function for gas and vapor delivery, the opening of which is closed at the circular periphery between the two disks by a cylindrical tube segment which preferably contains two or more openings for emission of the fluid mixture. The cylindrical chamber designed in this way is supplied in the same way with the fluid to be nebulized via an axially attached tube.

For the production of an “Aqua-Regia” aerosol 20 from precursor aerosols 52, 54, which are produced exclusively from chloride-containing source material, it is also possible that the described liquid chloride rotary nebulization device 160, 170 of, for example, titanium tetrachloride is provided with the described gas and/or vapor rotary emission device of nitrate- or nitric acid-forming gases in such a way that both emission sources form a well-mixed emission cloud in which the “Aqua-Regia” aerosol 20 is formed independently. Preferably, this is done in such a way that the axes of rotation of the two rotating emission devices for aerosol from the liquid phase and from the gas phase are largely brought into alignment in such a way that the rotating disk-shaped chambers are arranged parallel to each other at a small distance, for example a few centimeters.

Wind turbines can also be set up on platforms on largely flat glacial ice regions and are particularly suitable there because of the uniform katabatic wind flowing towards the coast and with regard to their tower-like construction as carriers of the described equipment for the production of “Aqua Regia” aerosol clouds 20. In addition, the electricity generated can be used for the various needs of “Aqua Regia” aerosol production.

It is apparent to the skilled person that the embodiments described above are to be understood as exemplary and that the disclosure is not limited to these, but can be varied in many ways without leaving the scope of protection of the claims. Furthermore, it is apparent that the features, irrespective of whether they are disclosed in the description, the claims, the figures or otherwise, also individually define essential components of the disclosure, even if they are described together with other features. In all figures, the same reference signs represent the same objects, so that descriptions of objects which may only be mentioned in one or at least not with respect to all figures can also be transferred to these figures, with respect to which the object is not explicitly described in the description.

1. A self-activating photoactive aerosol comprising: an anion-containing mass composition having a mass ratio of nitrate anions and/or nitrogen-oxygen compounds to chlorides of from 1 proportion nitrate anions and/or nitrogen-oxygen compounds to 200 proportions chlorides up to 10 proportions nitrate anions and/or nitrogen-oxygen compounds to 1 proportion chlorides, and a pH in a range of less than or equal to 3 to greater than or equal to −1.

2. The self-activating photoactive aerosol according to claim 1, wherein the anion-containing mass composition further comprises metal elements in a mass ratio of from 1 proportion metal elements to 1000 proportions of the nitrate anions up to 1 proportion metal elements to 3 proportions anions,
wherein the metal elements are comprised in the form of metal compounds, and/or
wherein the metal elements comprise ions or, respectively, ferric cations, ferrous ions or ferrous cations, ferric oxides, ferric hydroxides, iron(III) oxide hydrate, manganese cations, manganese(IV) oxides, manganese ions, permanganate ions, titanium compounds such as titanium dioxide, titanium tetrachloride and/or a hydrolysis product of titanium tetrachloride.

3. The self-activating photoactive aerosol according to claim 1, wherein the anion-containing mass composition comprises said nitrogen-oxygen-compounds in the form of metal-nitrogen-oxygen-compounds, comprising at least one substance out of the group metal nitrate, metal nitrite, iron nitrate, iron nitrite, titanium dioxide, hydrolysis products of titanium tetrachloride, silicon tetrachloride, aluminum chloride, iron(III) chloride, nitric acid, oxidation products, and/or hydrolysis products of NO, NO₂, NO₃, N₂O₃, N₂O₄, N₂O₅, NOCl, NO₂Cl, NO₃Cl.

4. The self-activating photoactive aerosol according to claim 3,
wherein the mass ratio between nitrogen-oxygen compounds to the chlorides in a condensed aerosol phase is between 0.5 parts in 100 parts and 10 parts in 1 part, and/or
wherein a proportion of nitrogen-oxygen compounds is oxidized and/or hydrolyzed to at least one proportion of nitrate and/or at least one proportion of nitric acid, and/or
wherein a bulk composition comprises nitric acid in such a proportion that the pH of the aerosol is adjusted between less than or equal to 3 to greater than or equal to −1.

5. The self-activating photoactive aerosol according to claim 1,
wherein the aerosol comprises droplets or particles in a cloud or plume, and/or
wherein after a completed chemical-physical reaction the anion-containing mass composition is present in the atmosphere to a predominant extent in a condensed phase, and/or
wherein the anion-containing mass composition during the chemical-physical reaction after emission of the aerosol is present in part to a predominant proportion as volatile or vaporous components in a gas phase.

6. The self-activating photoactive aerosol according to claim 1,
wherein the chlorides are present in the form of chloride anions and/or in dissolved or gaseous chloride compounds, and/or
wherein the chlorides comprise chlorine in the form of chloride anions and/or in at least one of the dissolved or gaseous states from the group consisting of atomic chlorine, elemental chlorine, hydrogen chloride, nitrosyl chloride, nitryl chloride or chlorine nitrate.

7. Use of a self-activating photoactive aerosol according to claim 1 under action of artificial or natural radiation for degradation of methane and/or gaseous, vaporous or aerosol-form organic greenhouse-active organic substances.

8. A method for producing a self-activating photoactive aerosol according to claim 1, the method characterized by the steps of:
Providing a first precursor with nitrate anions and/or nitrogen-oxygen compounds,
providing a second precursor with chlorides,
mixing the first and second precursors and adjusting a mass ratio in the range from 1 part nitrate anions and/or nitrogen-oxygen compounds to 200 parts chlorides up to 10 parts nitrate anions and/or nitrogen-oxygen compounds to 1-part chlorides to produce a chloride mixture aerosol, and
moderating the pH in a range from less than or equal to 3 to greater than or equal to −1.

9. The method according to claim 8,
wherein the chloride mixture aerosol further comprises metal compounds in the form of cations, molecules, oxides, hydroxides, particles and/or chemically bonded elements, wherein the metal compounds may be present as ferrous chloride, ferric chloride, ferrous nitrate, ferric nitrate, ferric hydrolysate of ferric chloride or ferric nitrate, iron pentacarbonyl, titanium tetrachloride and/or titanium-containing hydrolysate of titanium tetrachloride, and/or
wherein the chloride mixture aerosol comprises a proportion of iron tetrachloride and/or titanium-containing hydrolysate of titanium tetrachloride, titanium tetrachloride and/or titanium-containing hydrolysate of titanium tetrachloride, and/or
wherein the chloride mixture aerosol comprises a portion in condensed phase, and/or
wherein the second precursor comprises the chlorides in the form of a chlorine compound.

10. The method according to claim 8,
wherein a chloride aerosol and/or an auxiliary gas is used in the step of mixing the chloride mixture aerosol, and/or
wherein the step of mixing the chloride mixture aerosol is carried out by atomization and/or by means of ultrasonic vibration, and/or
wherein the step of mixing the chloride mixture aerosol is carried out using a non-thermal nebulization process, and/or
wherein the step of mixing the chloride mixture aerosol is carried out using at least one of a gas jet vacuum pump or static mixer as mixing and reaction member, and/or
for providing the chloride mixture aerosol nebulizing an aqueous chloride salt solution.

11. The method according to claim 8, addition of at least one substance from the group consisting of seawater, organosulfur compounds, elemental sulfur, diesel exhaust gas, plasma-chemically converted air, nitrogen-oxygen compounds to produce an “aqua-regia” precursor substance.

12. The method according to claim 8, wherein
the first precursor comprises at least one substance from the group consisting of metal nitrate, metal nitrite, iron nitrate, iron nitrite, titanium dioxide, hydrolysis product of titanium tetrachloride, nitric acid, NO, NO₂, NO₃, N₂O₃, N₂O₄, N₂O₅, and/or
in the first precursor an atomic ratio between oxygen and nitrogen is greater than or equal to 1, and/or the second precursor comprises chlorine compounds.

13. The method according to claim 8, wherein the step of providing the first precursor uses a plasma-chemical process and/or a plasma reactor to generate a plasma from atmospheric air, or to generate the nitrogen-oxygen compounds from oxygen and/or nitrogen contained in the atmospheric air.

14. The method according to claim 13,
wherein in the plasma-chemical process a non-thermal plasma is generated or maintained, or plasma glow discharge, corona discharge, silent electrical discharge with or without water contact, capacitive or inductive high-frequency discharge, microwave discharge, dielectrically impeded discharge, air plasma jet with water contact, or sliding arc discharge with water contact, wherein the process can be carried out in a vacuum or under atmospheric pressure, or
wherein a high-temperature plasma is generated or maintained in the plasma-chemical process, and/or
wherein a volume fraction of the first precursor generated with the plasma-chemical process and/or the plasma reactor is 1 vol % or more, of the self-activating photoactive aerosol to be produced.

15. The method according to claim 8, further in the step of providing the second precursor, use of a sublimation device for a pile bed, or consisting of or comprising anhydrous ferric chlorides.

16. The method according to claim 8,
wherein the mixing of the first and second precursors with each other is carried out in a partially enclosed environment, and/or
wherein after the step of mixing the first and second precursors, a mixed self-activating photoactive aerosol is ejected, or by using a pressurized gas, wherein the pressurized gas can be a vacuum-generating pressurized gas, and/or
wherein the mixed self-activating photoactive aerosol is ejected from at least one of the following staging locations: Ship, floating platform, oil rig, airplane, balloon, blimp, cooling tower, smokestack, exhaust, lattice tower, mountaintop, updraft power plant, wind turbine, the aforementioned onshore, offshore or glacier-borne possible.

17. Apparatus for providing a self-activating photoactive aerosol, according to claim 1, the apparatus comprising:
a reaction chamber,
a first means connected to a reaction space for providing a first precursor of nitrogen-containing compounds, in the reaction space, a second means connected to the reaction space for providing a second precursor comprising chlorine or chlorides in the reaction space,
a carrier gas providing device for providing a carrier gas in the reaction space,
wherein the device is adapted to bring about a mixture of the first and second precursor in the reaction space and thereby adjust a mass ratio in the range from 1 proportion of nitrate anions and/or nitrogen-oxygen compounds to 200 proportions of chlorides up to 10 proportions of nitrate anions and/or nitrogen-oxygen compounds to 1 proportion of chlorides,
wherein the device is further adapted to moderate the pH in a range from less than or equal to 3 to greater than or equal to −1.

18. The apparatus according to claim 17, wherein the first means comprises a plasma reactor for generating a plasma from atmospheric air.

19. The apparatus according to claim 18, wherein the plasma reactor generates or maintains a non-thermal plasma, and/or
wherein the plasma reactor comprises one of the following methods: plasma glow discharge, corona discharge, silent electric discharge with or without water contact, capacitive or inductive high-frequency discharge, microwave discharge, dielectrically impeded discharge, air plasma jet with water contact, or sliding arc discharge with water contact, and/or
wherein the plasma reactor is operated under vacuum or atmospheric pressure, and/or
wherein the plasma reactor provides or maintains a high-temperature plasma.

20. The apparatus according to claim 17,
wherein the carrier gas providing device comprises at least one of the following features: a gas jet, a pressurized gas system, an exhaust device, and/or
wherein the device is arranged such that the first means is connected to the reaction chamber via a NOx outlet, and/or
the second means is connected to the reaction chamber via a chloride outlet, and/or
the first means and the second means are connected to the reaction chamber via a common NOx/chloride outlet.

21. The apparatus according to claim 17, wherein the apparatus comprises at least one of the following features or devices:
an atomization system,
an ultrasonic vibration device,
a centrifugal pump for conveying and emitting gaseous or vaporous media,
a centrifugal pump for conveying liquid media and nebulizing them,
a nebulization plant for carrying out a nebulization process by condensation and/or hydrolysis,
a chlorination plant for iron chlorination,
a gas jet vacuum pump, and/or
a static mixer as a mixing and reaction element, which is arranged in or on the reaction chamber (40).

22. The apparatus according to claim 17, wherein the second means further comprises a sublimation device for a pile bed, the pile bed consisting of or comprising anhydrous ferric chloride.

23. The apparatus according to claim 22, wherein the pile bed is characterized by at least one of the following features:
a mixing device providing at least one of stirring, vibrating, shaking, circulating, or fluidizing by means of inert gas flow,
the mixing device providing grinding aids,
a gas flow system and/or evaporator system for providing an inert gas or inert vapor for flowing through the pile bed, wherein the inert vapor is provided by evaporation of at least one of silicon tetrachloride or titanium tetrachloride,
a heating device for heating the pile bed,
a temperature control device for controlling a temperature in the pile bed and/or in the gas flow system and/or evaporator system between 100 and 220° C.

24. The apparatus according to claim 17,
further comprising a vapor generator for generating a nitric acid vapor by supplying air and nitric acid into the vapor generator under elevated temperature and/or pressure, and/or
wherein a fogging system provides at least one of nozzle fogging, fogging by rotating impact elements, or an ultrasonic vibration fogging of liquid or aqueous chloride and/or nitrate solutions for generating a nitrate and/or chloride fog.

25. The apparatus according to claim 17, wherein the second means comprises a reaction device for an exothermic reaction of metals or alloys with chlorine gas, or further comprising a temperature control device for controlling a temperature in the reaction device between 450° C. to 600° C.

26. The apparatus according to claim 17,
wherein the device is prepared and set up on one of the following staging locations: ship, floating platform, off-shore platform with foundation, drilling platform, airplane, balloon, zeppelin, cooling tower, chimney, exhaust pipe, lattice mast, mountain top, upwind power plant, turbine, wind power plant, glacier-supported platform.

27. The apparatus according to claim 17,
wherein the reaction chamber is arranged in an enclosure with an outlet for releasing the self-activating photoactive aerosol,
wherein the reaction chamber is arranged in a cooling tower, chimney exhaust, lattice mast, updraft power plant, wind power plant or turbine.

28. Exhaust gas treatment device for at least partial conversion of exhaust gases and for simultaneous provision of a self-activating photoactive aerosol, according to claim 1, the exhaust gas treatment device comprising
a reaction chamber arranged in a pipe section prepared for exhaust gas discharge, or in an exhaust pipe or chimney,
a first device for providing a first precursor comprising nitrate anions and/or nitrogen-oxygen compounds in the reaction chamber,
a second device for providing a second precursor comprising chlorides in the reaction chamber,
an exhaust gas emitter, as a carrier gas providing device for providing the carrier gas fin the reaction space,
the device being adapted to bring about a mixture of the first and second precursors in the reaction chamber and to set a mass ratio in the range from 1 proportion of nitrate anions and/or nitrogen-oxygen compounds to 200 proportions of chlorides up to 10 proportions of nitrate anions and/or nitrogen-oxygen compounds to 1 proportion of chlorides,
wherein the device is further adapted to moderate the pH in a range from less than or equal to 3 to greater than or equal to −1.
